(19) United States
(12) Patent Application Publication
(10) Pub. No.: US 2026/0332952 A1
(43) Pub. Date: Oct. 22, 2026

(54) PROXIMITY-BASED POWER MANAGEMENT FOR AUDIO PLAYBACK DEVICES

(71) Applicant: Sonos, Inc., Goleta, CA (US)

(72) Inventors: Joern Riemer, Trabuco Canyon, CA (US); Matthew Benatan, Stockport (GB); Adib Mehrabi, London (GB)

(21) Appl. No.: 19/104,585

(22) PCT Filed: Aug. 10, 2023
(86) PCT No.: PCT/US2023/072040

§ 371 Date: Feb. 18, 2025

Related U.S. Application Data
(60) Provisional application No. 63/371,828, filed on Aug. 18, 2022.
(60) Provisional application No. 63/371,834, filed on Aug. 18, 2022.

(51) Int. Cl. H04R 3/12

(52) U.S. Cl. CPC H04R 3/12; H04R 2227/005; H04R 2430/01

(57) ABSTRACT

Disclosed herein are systems and methods for proximity-based power management for audio playback devices. In a first mode, a portable audio playback device plays back audio content in full. In a second mode, the portable playback device plays back only a first portion of the audio content itself and routes a second portion of the audio content to a nearby playback device, which may be stationary or portable. The portable playback device can transition between the first mode and the second mode based on a proximity parameter of the portable playback device and/or the nearby playback device, a power parameter of the portable playback device and/or the nearby playback device, or a grouping parameter of the portable playback device and/or the nearby playback device.

### CROSS-REFERENCE TO RELATED APPLICATIONS

This application claims priority to U.S. Provisional Application No. 63/371,828, filed Aug. 18, 2022; and U.S. Provisional Application No. 63/371,834, filed Aug. 18, 2022; each of which is hereby incorporated by reference in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A shows a partial cutaway view of an environment having a media playback system configured in accordance with aspects of the disclosed technology.

FIG. 1B shows a schematic diagram of the media playback system of FIG. 1A and one or more networks.

FIG. 1C shows a block diagram of a playback device.

FIG. 1D shows a block diagram of a playback device.

FIG. 1E shows a block diagram of a network microphone device.

FIG. 1F shows a block diagram of a network microphone device.

FIG. 1G shows a block diagram of a playback device.

FIG. 1H shows a partially schematic diagram of a control device.

FIGS. 1I through 1L show schematic diagrams of corresponding media play back system zones.

FIG. 1M shows a schematic diagram of media playback system areas.

FIG. 2A shows a front isometric view of a playback device configured in accordance with aspects of the disclosed technology.

FIG. 2B shows a front isometric view of the playback device of FIG. 3A without a grille.

FIG. 2C shows an exploded view of the playback device of FIG. 2A.

FIG. 2D is a diagram of another example housing for a playback device.

FIG. 2E is a diagram of another example housing for a playback device.

FIG. 3A shows a front view of a network microphone device configured in accordance with aspects of the disclosed technology.

FIG. 3B shows a side isometric view of the network microphone device of FIG. 3A.

FIG. 3C shows an exploded view of the network microphone device of FIGS. 3A and 3B.

FIG. 3D shows an enlarged view of a portion of FIG. 3B.

FIG. 3E shows a block diagram of the network microphone device of FIGS. 3A-3D.

FIG. 3F shows a schematic diagram of an example voice input.

FIGS. 4A-4D show schematic diagrams of a control device in various stages of operation in accordance with aspects of the disclosed technology.

FIG. 5 shows front view of a control device.

FIG. 6 shows a message flow diagram of a media playback system.

FIG. 7 shows an example configuration of a wireless power transfer device in accordance with the disclosed technology.

FIG. 8 shows an example configuration of a wireless power group in accordance with the disclosed technology.

FIG. 9 is a schematic illustration of a media playback system including portable playback devices in accordance with the disclosed technology.

FIG. 10 illustrates example frequency response curve for a portable playback device operating in a first mode in accordance with the disclosed technology.

FIG. 11 illustrates example frequency response curves for a portable playback device and a stationary plug-in playback device operating in a second mode in accordance with the disclosed technology.

FIG. 12 illustrates example frequency response curves for portable playback devices operating in first and second modes in accordance with the disclosed technology.

FIGS. 13 and 14 are flow charts of example methods for proximity-based power management of portable playback devices in accordance with the disclosed technology.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Portable audio playback devices provide many advantages over stationary plug-in play back devices. Such portable devices can include internal, rechargeable batteries that permit users to move the devices at will and to continue audio playback even when the devices are not coupled to an external power source. Typically, such portable devices can be recharged by placing the portable playback device on a charging stand or by connecting a charging cable to the playback device. One problem with such portable playback devices, however, is the risk of running out of power due to extended use without recharging. This can be particularly problematic if the device loses power during playback, as the abrupt cessation of audio output can be jarring to a listener. While increasing battery capacity can increase the possible runtime of such devices, this can also increase the weight, size, and cost of such devices.

Examples of the present technology address these and other problems by intelligently managing the power consumption of such portable playback devices. In particular, since the audio output by a particular portable playback device can have a significant effect on its power consumption, the audio output can be modified to conserve power under certain conditions. For example, as the power level falls below a predetermined threshold, the audio playback can be modified to reduce power consumption and preserve some playback capability for a longer duration. Bass-heavy audio output is particularly power-intensive, and as such modifying the audio playback to include less low-frequency audio output can extend the playback time of a portable playback device with a lower level of stored power. However, reducing the low-frequency output of the portable playback device can also lead to a diminished user experience. Accordingly, it can be useful to augment or supplement the modified audio output by the portable playback device by synchronously playing back audio via another nearby playback device. For example, consider the scenario in which a user is listening to audio on a portable playback device positioned on a living room coffee table, while a stationary plug-in playback device is positioned on a nearby bookshelf. In response to the battery level of the portable playback device dropping below a threshold, the portable playback device can transition to a second mode in which less low-frequency audio content is output by the portable device, while simultaneously the nearby stationary plug-in playback device can begin to synchronously output low-frequency audio content to augment the audio being played back by the portable playback device. In this manner, the low-frequency audio content is still output for the user, while the portable playback device reduces its power consumption and extends its playback time before needing to be recharged. Moreover, because low-frequency content is more omnidirectional than higher-frequency content, the user may be less able to localize the source of the low-frequency content as coming from the nearby stationary plug-in device on the bookshelf rather than the portable playback device on the coffee table.

This approach can be extended to numerous different use cases in which the playback responsibilities for a portable playback device can be modified and/or at least some playback responsibilities can be offloaded to nearby devices. For instance, in some examples two portable playback devices can play back audio content in synchrony. If the energy storage level of the first portable playback device is significantly lower than the energy storage level of the second portable playback device, then the playback responsibilities of one or both devices can be modified in a manner that reduces the power consumption rate of the first playback device and optionally increases the power consumption rate of the second playback device. For instance, the second playback device may begin to output a greater proportion of low-frequency audio content and the first playback device may begin to output a lesser proportion of low-frequency audio content. This configuration may persist until the two devices have the same or similar energy storage levels, at which time their previous playback responsibilities can be resumed (e.g., with each device outputting substantially the same levels of low-frequency audio content).

In various examples, the offloading of low-frequency audio content from a portable playback device to one or more other playback devices within the environment can be based on a power parameter of the portable playback device (e.g., energy storage level, power consumption rate, etc.), a power parameter of the nearby playback device (e.g., whether the nearby device is a stationary plugged-in device, the charge level of the nearby playback device etc.), a proximity parameter (e.g., a distance between the playback devices), a battery temperature (e.g., since batteries tend to be more efficient at higher temperatures, or to prevent excessive temperature that may damage the battery), or any other suitable parameter. Additionally or alternatively to modifying the acoustic output, certain operations of the portable playback device may also be modified depending on energy storage levels. For example, when energy storage levels fall below a predetermined threshold, certain functions can be disabled (e.g., turning off microphones, disabling a Bluetooth antenna, etc.).

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

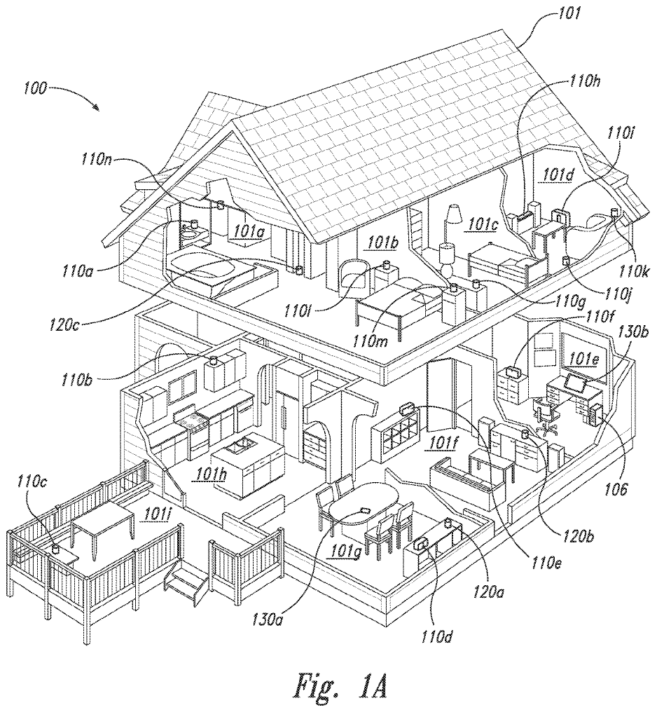

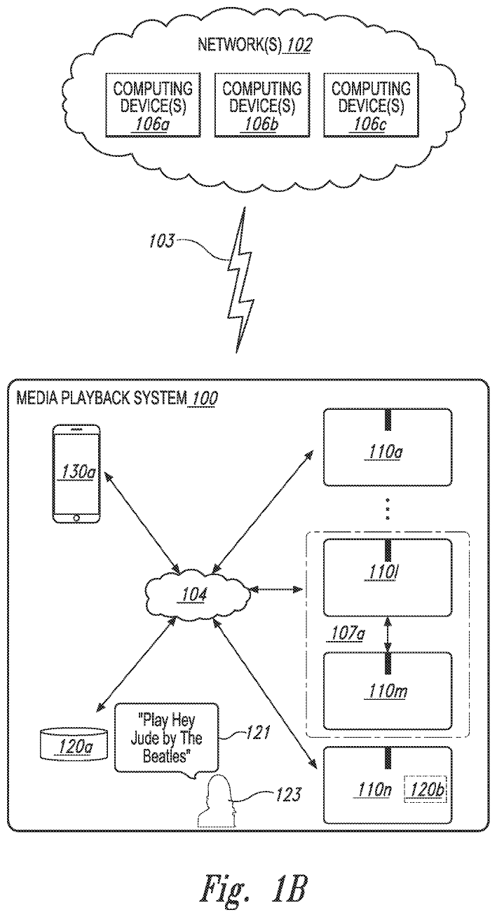

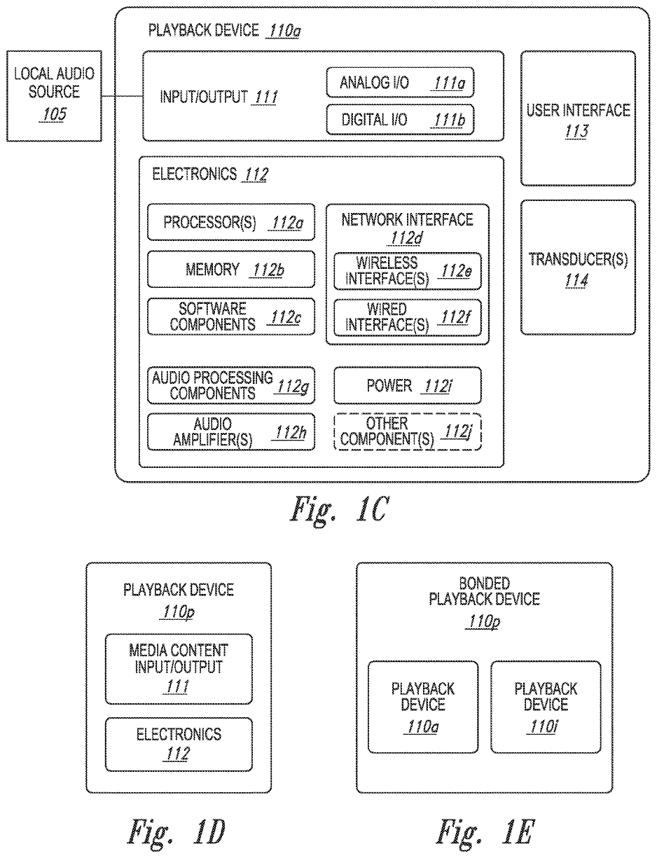

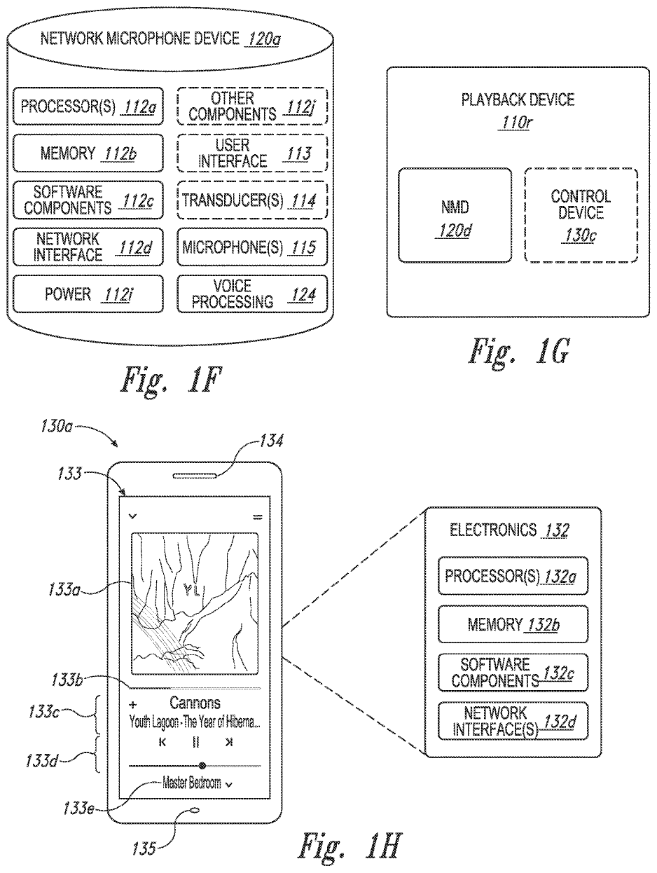

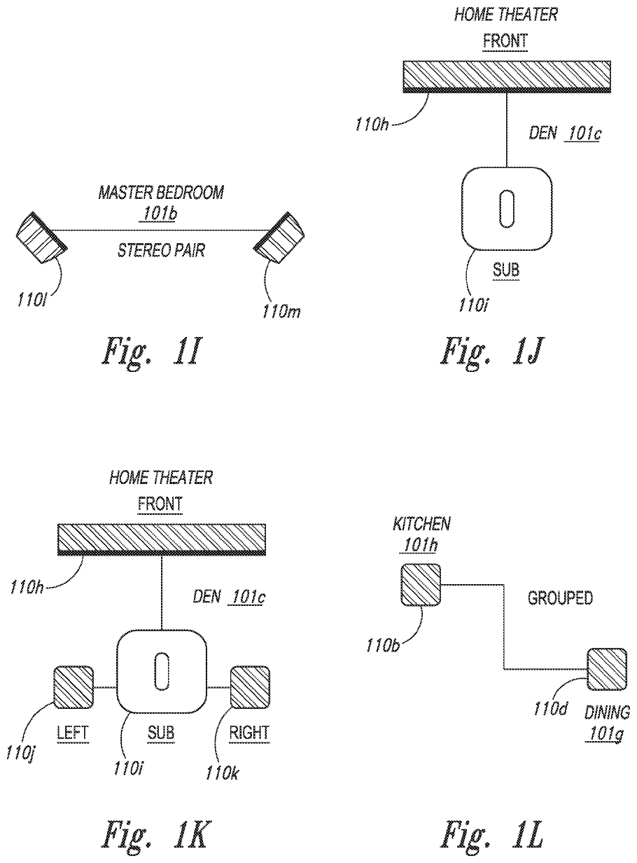

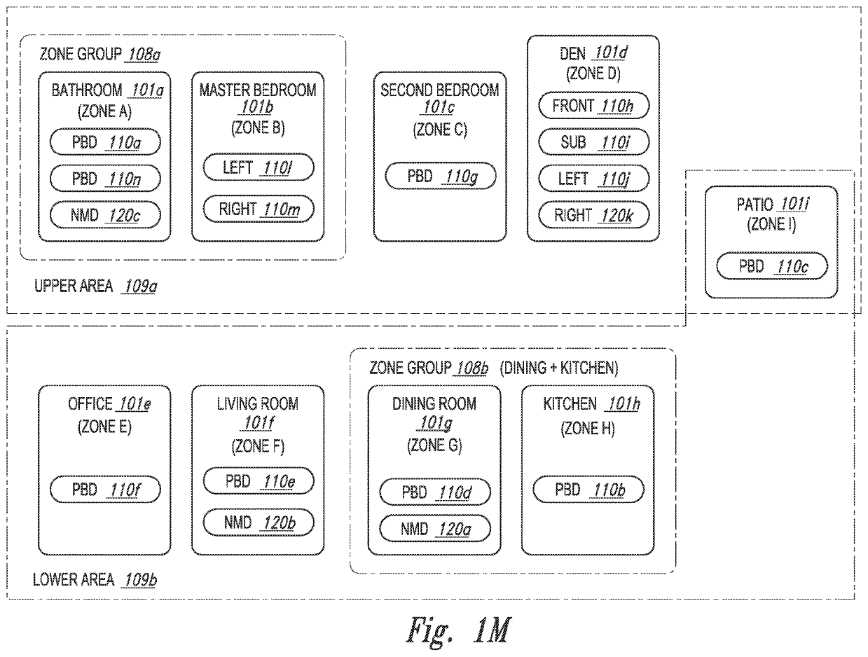

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices (“NMDs”), 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the play back devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1L.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the patio 101i. In some aspects, a single playback zone may include multiple rooms or spaces. In certain aspects, a single room or space may include multiple playback zones.

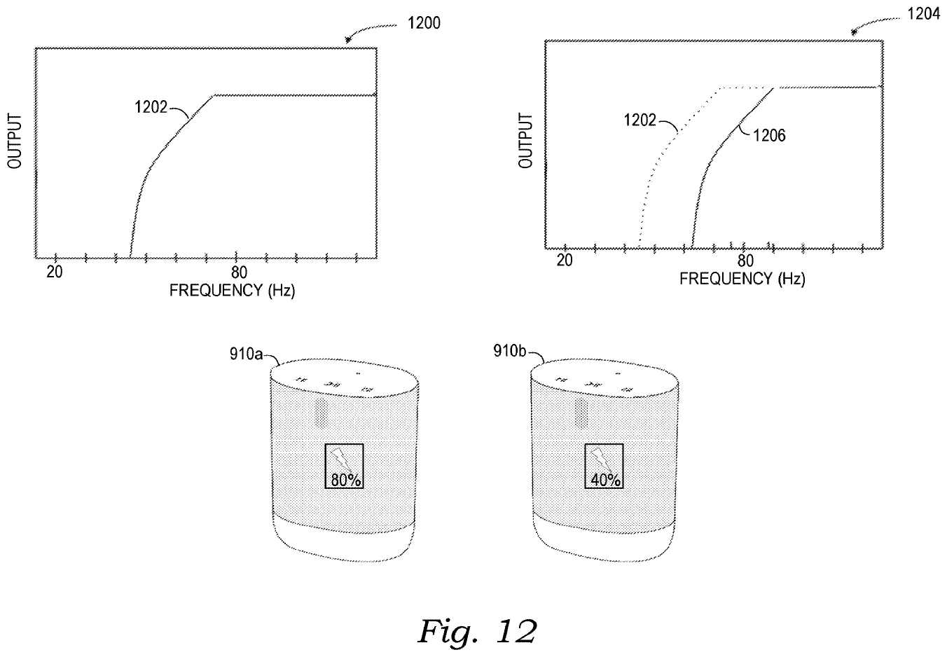

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to, for example, FIGS. 1B and 1E and 11-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

To facilitate synchronous playback, the playback device(s) described herein may, in some embodiments, be configurable to operate in (and/or switch between) different modes such as an audio playback group coordinator mode and/or an audio playback group member mode. While operating in the audio playback group coordinator mode, the playback device may be configured to coordinate playback within the group by, for example, performing one or more of the following functions: (i) receiving audio content from an audio source, (ii) using a clock (e.g., a physical clock or a virtual clock) in the playback device to generate playback timing information for the audio content, (iii) transmitting portions of the audio content and play back timing for the portions of the audio content to at least one other playback device (e.g., at least one other playback device operating in an audio playback group member mode), (iv) transmitting timing information (e.g., generated using the clock to the at least one other playback device; and/or (v) playing back the audio content in synchrony with the at least one other playback device using the generated playback timing information and/or the clock. While operating in the audio playback group member mode, the playback device may be configured to perform one or more of the following functions: (i) receiving audio content and playback timing for the audio content from the at least one other device (e.g., a playback device operating in an audio playback group coordinator mode); (ii) receiving timing information from the at least one other device (e.g., a playback device operating in an audio playback group coordinator mode); and/or (iii) playing the audio content in synchrony with at least the other playback device using the playback timing for the audio content and/or the timing information.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN) (e.g., the Internet), one or more local area networks (LAN) (e.g., one or more WIFI networks), one or more personal area networks (PAN) (e.g., one or more BLUETOOTH networks, Z-WAVE networks, wireless Universal Serial Bus (USB) networks, ZIGBEE networks, and/or IRDA networks), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g. voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media play back system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHZ, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media play back system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct or indirect connections, PANs, LANs, telecommunication networks, and/or other suitable communication links.

In some embodiments, audio content sources may be regularly added or removed from the media playback system 100. In some embodiments, for example, the media play back system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1-I through IM.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) transmit a corresponding command to the media playback system 100. In some aspects, for example, the computing device 106c comprises one or more modules and/or servers of a VAS (e.g., a VAS operated by one or more of SONOS®, AMAZON®, GOOGLER APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media playback system 100 to play back “Hey Jude” by the Beatles from a suitable media service (e.g., via one or more of the computing devices 106) on one or more of the playback devices 110.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication protocol. In certain embodiments, the analog I/O 111a and the digital I/O 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 is configured to receive audio from an audio source (e.g., the local audio source 105) via the input/output 111, one or more of the computing devices 106a-c via the network 104 (FIG. 1B), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

As described in more detail elsewhere herein, in some examples the power components 112i can include one or more of: a wireless power transmitter (e.g., a laser, induction coils, etc.), a wireless power receiver (e.g., a photovoltaic cell, induction coils, etc.), an energy storage component (e.g., a capacitor, a rechargeable battery), an energy harvester, a wired power input port, and/or associated power circuitry. In operation, the playback device 110a can be configured to transmit wireless power to one or more external devices. Additionally or alternatively, the playback device 110a can be configured to receive wireless power from one or more external transmitter devices, instead of or in addition to receiving power over a wired connection.

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio information from an audio source (e.g., one or more of the computing devices 106a-c (FIG. 1B)), and/or another one of the playback devices 110. In some embodiments, the operations further include causing the playback device 110a to send audio information to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous play back of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media play back system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio processing components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY: 1,” “PLAY: 3,” “PLAY: 5,” “PLAYBAR,” “PLAYBASE,” “CONNECT: AMP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). The headphone may comprise a headband coupled to one or more earcups. For example, a first earcup may be coupled to a first end of the headband and a second earcup may be coupled to a second end of the headband that is opposite the first end. Each of the one or more earcups may house any portion of the electronic components in the playback device, such as one or more transducers. Further, the one or more of earcups may include a user interface for controlling operation of the headphone such as for controlling audio playback, volume level, and other functions. The user interface may include any of a variety of control elements such as buttons, knobs, dials, touch-sensitive surfaces, and/or touchscreens. An ear cushion may be coupled each of the one or more earcups. The ear cushions may provide a soft barrier between the head of a user and the one or more earcups to improve user comfort and/or provide acoustic isolation from the ambient (e.g., provide passive noise reduction (PNR)). Additionally (or alternatively), the headphone may employ active noise reduction (ANR) techniques to further reduce the user's perception of outside noise during playback.

In some instances, the headphone device may take the form of a hearable device. Hearable devices may include those headphone devices (e.g., ear-level devices) that are configured to provide a hearing enhancement function while also supporting play back of media content (e.g., streaming media content from a user device over a PAN, streaming media content from a streaming music service provider over a WLAN and/or a cellular network connection, etc.). In some instances, a hearable device may be implemented as an in-ear headphone device that is configured to playback an amplified version of at least some sounds detected from an external environment (e.g., all sound, select sounds such as human speech, etc.).

In some embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

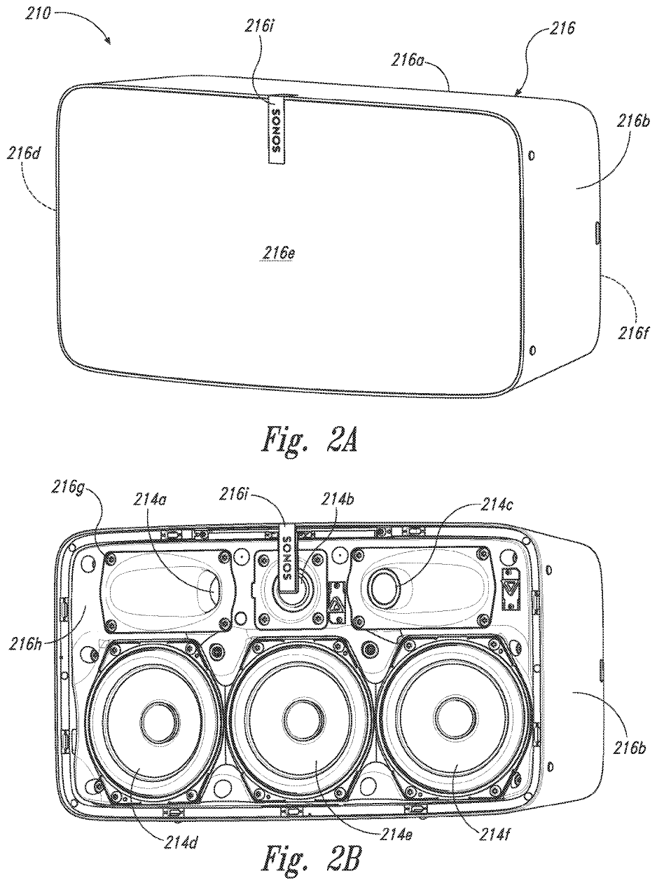

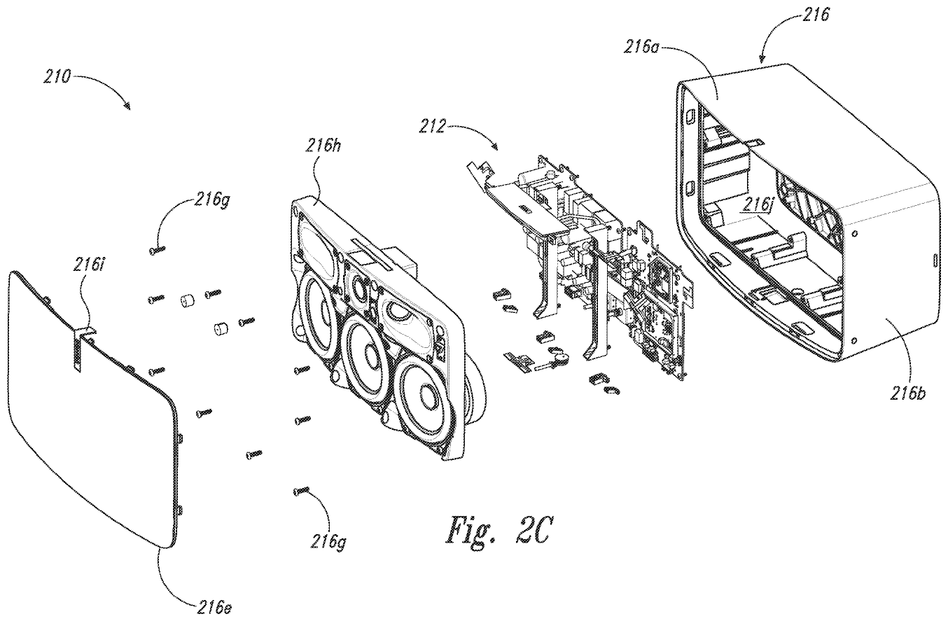

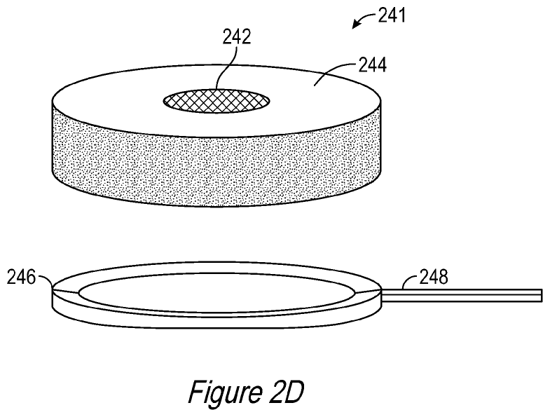

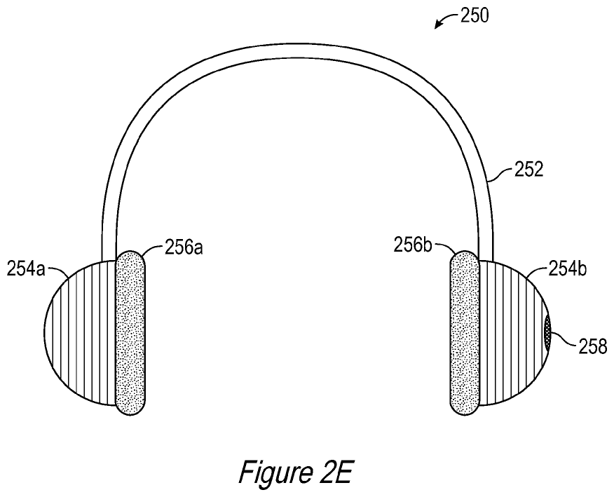

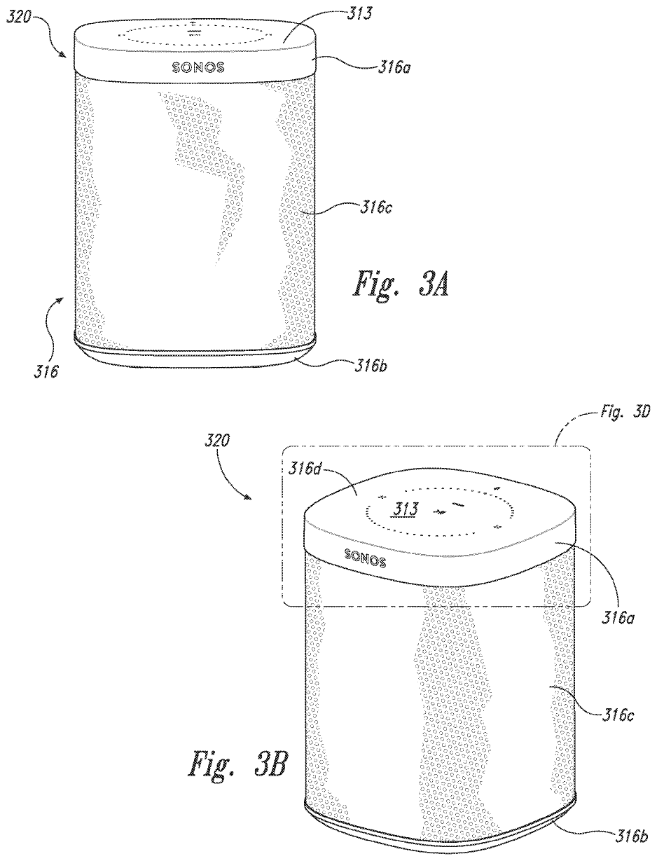

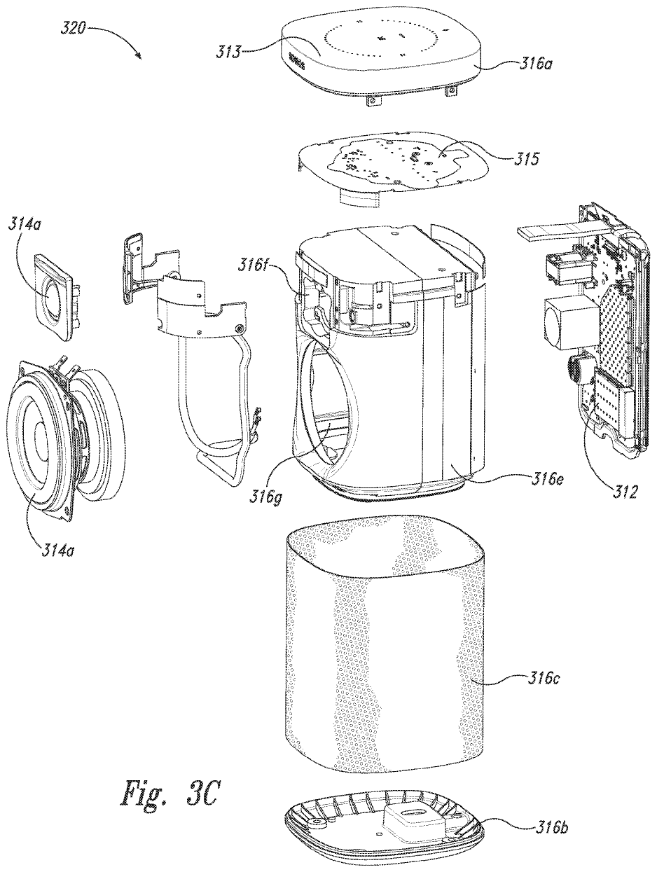

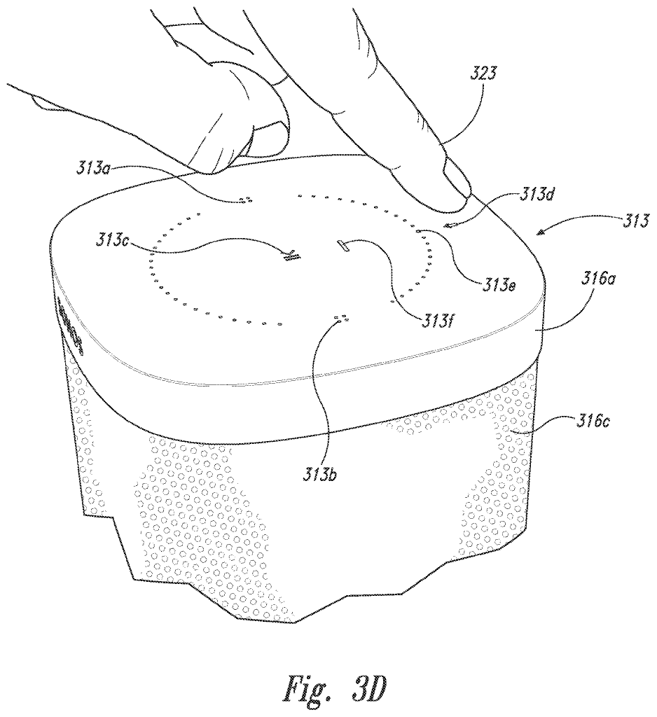

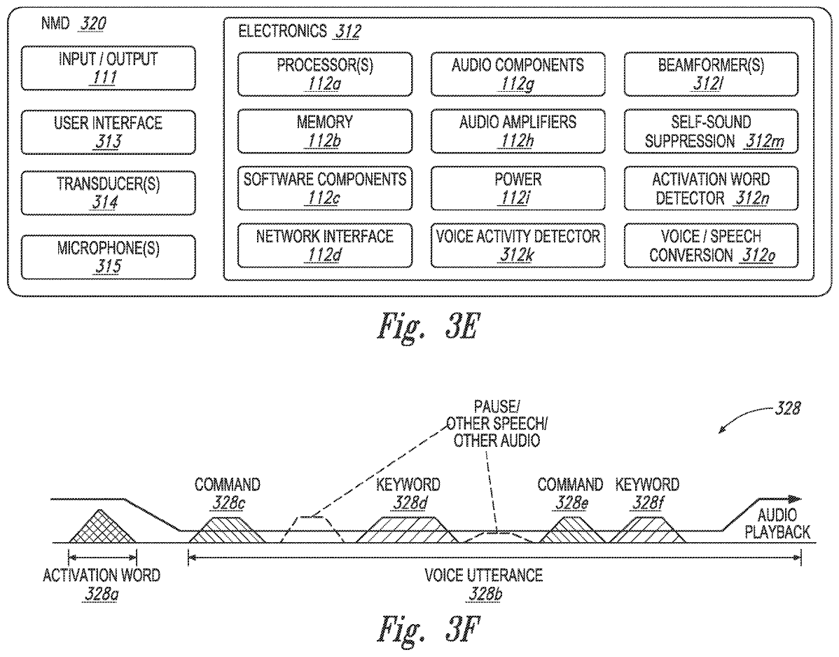

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device. Additional playback device embodiments are described in further detail below with respect to FIGS. 2A-3D.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, the power components 112i, and the microphones 115. As described elsewhere herein, the power components 112i can include one or more of: a wireless power transmitter (e.g., a laser, induction coils, etc.), a wireless power receiver (e.g., a photovoltaic cell, induction coils, etc.), an energy storage component (e.g., a capacitor, a rechargeable battery), an energy harvester, a wired power input port, and/or associated power circuitry. In operation, an NMD 120a can be configured to transmit wireless power to one or more external devices. Additionally or alternatively, the NMD 120a can be configured to receive wireless power from one or more external transmitter devices, in addition to or instead of receiving power over a wired connection.

The NMD 120a optionally comprises other components also included in the play back device 110a (FIG. 1C), such as the user interface 113 and/or the transducers 114. In some embodiments, the NMD 120a is configured as a media playback device (e.g., one or more of the playback devices 110), and further includes, for example, one or more of the audio processing components 112g (FIG. 1C), the transducers 114, and/or other playback device components. In certain embodiments, the NMD 120a comprises an Internet of Things (IOT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B). Additional NMD embodiments are described in further detail below with respect to FIGS. 3A-3F.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLER VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home. Additional description regarding receiving and processing voice input data can be found in further detail below with respect to FIGS. 3A-3F.

d. Suitable Control Devices

FIG. 1H is a partially schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media play back system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media play back systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of playback devices. The network interface 132d can also transmit and/or receive configuration changes such as, for example, adding/removing one or more playback devices to/from a zone, adding/removing one or more zones to/from a zone group, forming a bonded or consolidated player, separating one or more playback devices from a bonded or consolidated player, among others. Additional description of zones and groups can be found below with respect to FIGS. 1-I through 1M.

The user interface 133 is configured to receive user input and can facilitate ‘control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

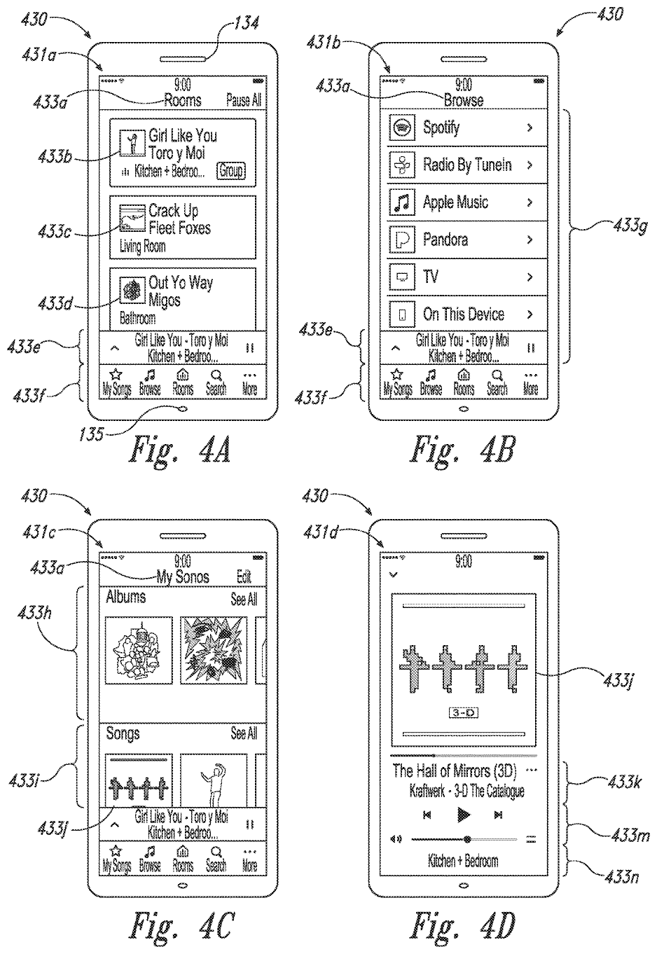

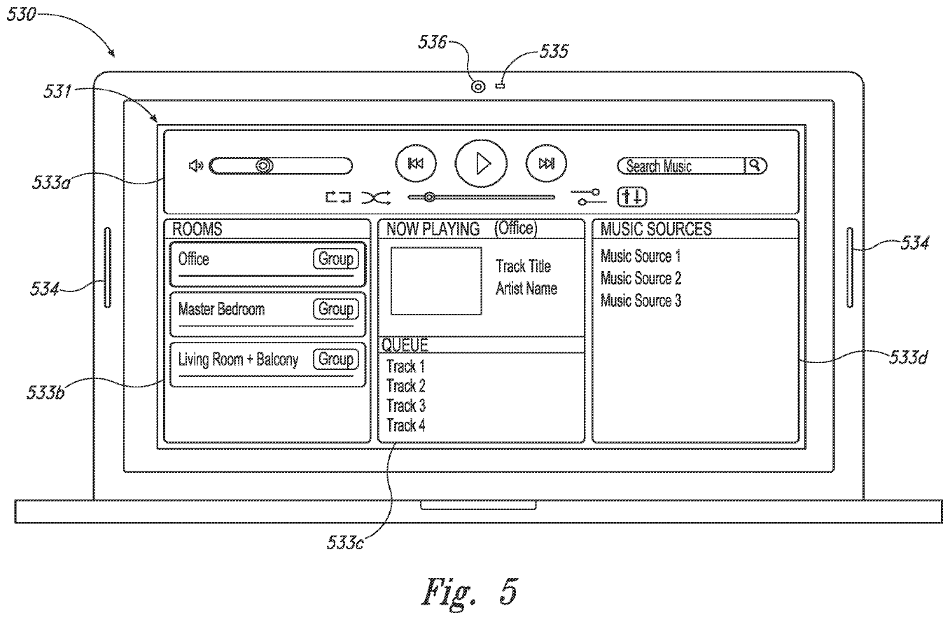

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones. Additional control device embodiments are described in further detail below with respect to FIGS. 4A-4D and 5.

e. Suitable Playback Device Configurations

FIGS. 1-I through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110l (e.g., a left playback device) to form Zone A. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110g and 110h can be merged to form a merged group or a zone group 108b. The merged playback devices 110g and 110h may not be specifically assigned different playback responsibilities. That is, the merged playback devices 110h and 110i may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1-I, the playback devices 110l and 110m may be bonded so as to produce or enhance a stereo effect of audio content. In this example, the playback device 110l may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured render low frequencies. When unbonded, however, the Front device 110h can be configured render a full range of frequencies. As another example, FIG. 1K shows the Front and SUB devices 110h and 110i further bonded with Left and Right playback devices 110j and 110k, respectively. In some implementations, the Right and Left devices 110j and 102k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. patent application Ser. No. 15/438,749.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can have be assigned a name such as “Dining+Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “cl” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the media playback system 100 may variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some embodiments, the media playback system 100 may not implement Areas, in which case the system may not store variables associated with Areas.

### III. Example Systems and Devices

FIG. 2A is a front isometric view of a playback device 210 configured in accordance with aspects of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion 216c, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) is configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some embodiments, the playback device 210 includes a number of transducers different than those illustrated in FIGS. 2A-2C. For example, as described in further detail below with respect to FIGS. 3A-3C, the playback device 210 can include fewer than six transducers (e.g., one, two, three). In other embodiments, however, the playback device 210 includes more than six transducers (e.g., nine, ten). Moreover, in some embodiments, all or a portion of the transducers 214 are configured to operate as a phased array to desirably adjust (e.g., narrow or widen) a radiation pattern of the transducers 214, thereby altering a user's perception of the sound emitted from the playback device 210.

In the illustrated embodiment of FIGS. 2A-2C, a filter 216i is axially aligned with the transducer 214b. The filter 216i can be configured to desirably attenuate a predetermined range of frequencies that the transducer 214b outputs to improve sound quality and a perceived sound stage output collectively by the transducers 214. In some embodiments, however, the playback device 210 omits the filter 216i. In other embodiments, the playback device 210 includes one or more additional filters aligned with the transducers 214b and/or at least another of the transducers 214.

In some examples, the playback device 210 may be constructed as a portable playback device, such as an ultra-portable playback device, that comprises an internal power source. FIG. 2D shows an example housing 241 for such a portable playback device. As shown, the housing 241 of the portable playback device includes a user interface in the form of a control area 242 at a top portion 244 of the housing 241. The control area 242 may include a capacitive touch sensor for controlling audio playback, volume level, and other functions. The housing 241 of the portable playback device may be configured to engage with a dock 246 that is connected to an external power source via cable 248. The dock 246 may be configured to provide power to the portable playback device to recharge an internal battery. In some examples, the dock 246 may comprise a set of one or more conductive contacts (not shown) positioned on the top of the dock 246 that engage with conductive contacts on the bottom of the housing 241 (not shown). In other examples, the dock 246 may provide power from the cable 248 to the portable playback device without the use of conductive contacts. For example, the dock 246 may wirelessly charge the portable playback device via one or more inductive coils integrated into each of the dock 246 and the portable playback device.

In some examples, the playback device 210 may take the form of a wired and/or wireless headphone (e.g., an over-ear headphone, an on-ear headphone, or an in-ear headphone). For instance, FIG. 2E shows an example housing 250 for such an implementation of the playback device 210. As shown, the housing 250 includes a headband 252 that couples a first earpiece 254a to a second earpiece 254b. Each of the earpieces 254a and 254b may house any portion of the electronic components in the playback device, such as one or more speakers, and one or more microphones. In some instances, the housing 250 can enclose or carry one or more microphones. Further, one or more of the earpieces 254a and 254b may include a control area 258 for controlling audio playback, volume level, and other functions. The control area 258 may comprise any combination of the following: a capacitive touch sensor, a button, a switch, and a dial. As shown in FIG. 2D, the housing 250 may further include ear cushions 256a and 256b that are coupled to earpieces 254a and 254b, respectively. The ear cushions 256a and 256b may provide a soft barrier between the head of a user and the earpieces 254a and 254b, respectively, to improve user comfort and/or provide acoustic isolation from the ambient (e.g., passive noise reduction (PNR)). In some implementations, the wired and/or wireless headphones may be ultra-portable playback devices that are powered by an internal energy source and weigh less than fifty ounces.

In some examples, the playback device 210 may take the form of an in-ear headphone device. It should be appreciated that the playback device 210 may take the form of other wearable devices separate and apart from a headphone. Wearable devices may include those devices configured to be worn about a portion of a subject (e.g., a head, a neck, a torso, an arm, a wrist, a finger, a leg, an ankle, etc.). For example, the playback device 210 may take the form of a pair of glasses including a frame front (e.g., configured to hold one or more lenses), a first temple rotatably coupled to the frame front, and a second temple rotatable coupled to the frame front. In this example, the pair of glasses may comprise one or more transducers integrated into at least one of the first and second temples and configured to project sound towards an ear of the subject.

While specific implementations of playback and network microphone devices have been described herein, there are numerous configurations of devices, including, but not limited to, those having no UI, microphones in different locations, multiple microphone arrays positioned in different arrangements, and/or any other configuration as appropriate to the requirements of a given application. For example, UIs and/or microphone arrays can be implemented in other playback devices and/or computing devices rather than those described herein. Further, although a specific example of playback device 210 is described with reference to MPS 100, one skilled in the art will recognize that playback devices as described herein can be used in a variety of different environments, including (but not limited to) environments with more and/or fewer elements, without departing from this invention. Likewise, MPSs as described herein can be used with various different playback devices.

FIGS. 3A and 3B are front and right isometric side views, respectively, of an NMD 320 configured in accordance with embodiments of the disclosed technology. FIG. 3C is an exploded view of the NMD 320. FIG. 3D is an enlarged view of a portion of FIG. 3B including a user interface 313 of the NMD 320. Referring first to FIGS. 3A-3C, the NMD 320 includes a housing 316 comprising an upper portion 316a, a lower portion 316b and an intermediate portion 316c (e.g., a grille). A plurality of ports, holes or apertures 316d in the upper portion 316a allow sound to pass through to one or more microphones 315 (FIG. 3C) positioned within the housing 316. The one or more microphones 315 are configured to received sound via the apertures 316d and produce electrical signals based on the received sound. In the illustrated embodiment, a frame 316e (FIG. 3C) of the housing 316 surrounds cavities 316f and 316g configured to house, respectively, a first transducer 314a (e.g., a tweeter) and a second transducer 314b (e.g., a mid-woofer, a midrange speaker, a woofer). In other embodiments, however, the NMD 320 includes a single transducer, or more than two (e.g., two, five, six) transducers. In certain embodiments, the NMD 320 omits the transducers 314a and 314b altogether.

Electronics 312 (FIG. 3C) includes components configured to drive the transducers 314a and 314b, and further configured to analyze audio information corresponding to the electrical signals produced by the one or more microphones 315. In some embodiments, for example, the electronics 312 comprises many or all of the components of the electronics 112 described above with respect to FIG. 1C. In certain embodiments, the electronics 312 includes components described above with respect to FIG. 1F such as, for example, the one or more processors 112a, the memory 112b, the software components 112c, the network interface 112d, etc. In some embodiments, the electronics 312 includes additional suitable components (e.g., proximity or other sensors).

Referring to FIG. 3D, the user interface 313 includes a plurality of control surfaces (e.g., buttons, knobs, capacitive surfaces) including a first control surface 313a (e.g., a previous control), a second control surface 313b (e.g., a next control), and a third control surface 313c (e.g., a play and/or pause control). A fourth control surface 313d is configured to receive touch input corresponding to activation and deactivation of the one or microphones 315. A first indicator 313e (e.g., one or more light emitting diodes (LEDs) or another suitable illuminator) can be configured to illuminate only when the one or more microphones 315 are activated. A second indicator 313f (e.g., one or more LEDs) can be configured to remain solid during normal operation and to blink or otherwise change from solid to indicate a detection of voice activity. In some embodiments, the user interface 313 includes additional or fewer control surfaces and illuminators. In one embodiment, for example, the user interface 313 includes the first indicator 313e, omitting the second indicator 313f. Moreover, in certain embodiments, the NMD 320 comprises a playback device and a control device, and the user interface 313 comprises the user interface of the control device.

Referring to FIGS. 3A-3D together, the NMD 320 is configured to receive voice commands from one or more adjacent users via the one or more microphones 315. As described above with respect to FIG. 1B, the one or more microphones 315 can acquire, capture, or record sound in a vicinity (e.g., a region within 10 m or less of the NMD 320) and transmit electrical signals corresponding to the recorded sound to the electronics 312. The electronics 312 can process the electrical signals and can analyze the resulting audio data to determine a presence of one or more voice commands (e.g., one or more activation words). In some embodiments, for example, after detection of one or more suitable voice commands, the NMD 320 is configured to transmit a portion of the recorded audio data to another device and/or a remote server (e.g., one or more of the computing devices 106 of FIG. 1B) for further analysis. The remote server can analyze the audio data, determine an appropriate action based on the voice command, and transmit a message to the NMD 320 to perform the appropriate action. For instance, a user may speak “Sonos, play Michael Jackson.” The NMD 320 can, via the one or more microphones 315, record the user's voice utterance, determine the presence of a voice command, and transmit the audio data having the voice command to a remote server (e.g., one or more of the remote computing devices 106 of FIG. 1B, one or more servers of a VAS and/or another suitable service). The remote server can analyze the audio data and determine an action corresponding to the command. The remote server can then transmit a command to the NMD 320 to perform the determined action (e.g., play back audio content related to Michael Jackson). The NMD 320 can receive the command and play back the audio content related to Michael Jackson from a media content source. As described above with respect to FIG. 1B, suitable content sources can include a device or storage communicatively coupled to the NMD 320 via a LAN (e.g., the network 104 of FIG. 1B), a remote server (e.g., one or more of the remote computing devices 106 of FIG. 1B), etc. In certain embodiments, however, the NMD 320 determines and/or performs one or more actions corresponding to the one or more voice commands without intervention or involvement of an external device, computer, or server.

FIG. 3E is a functional block diagram showing additional features of the NMD 320 in accordance with aspects of the disclosure. The NMD 320 includes components configured to facilitate voice command capture including voice activity detector component(s) 312k, beam former components 312l, acoustic echo cancellation (AEC) and/or self-sound suppression components 312m, activation word detector components 312n, and voice/speech conversion components 312o (e.g., voice-to-text and text-to-voice). In the illustrated embodiment of FIG. 3E, the foregoing components 312k-312o are shown as separate components. In some embodiments, however, one or more of the components 312k-312o are subcomponents of the processors 112a.

The beamforming and self-sound suppression components 312l and 312m are configured to detect an audio signal and determine aspects of voice input represented in the detected audio signal, such as the direction, amplitude, frequency spectrum, etc. The voice activity detector activity components 312k are operably coupled with the beamforming and AEC components 312l and 312m and are configured to determine a direction and/or directions from which voice activity is likely to have occurred in the detected audio signal. Potential speech directions can be identified by monitoring metrics which distinguish speech from other sounds. Such metrics can include, for example, energy within the speech band relative to background noise and entropy within the speech band, which is measure of spectral structure. As those of ordinary skill in the art will appreciate, speech typically has a lower entropy than most common background noise. The activation word detector components 312n are configured to monitor and analyze received audio to determine if any activation words (e.g., wake words) are present in the received audio. The activation word detector components 312n may analyze the received audio using an activation word detection algorithm. If the activation word detector 312n detects an activation word, the NMD 320 may process voice input contained in the received audio. Example activation word detection algorithms accept audio as input and provide an indication of whether an activation word is present in the audio. Many first- and third-party activation word detection algorithms are known and commercially available. For instance, operators of a voice service may make their algorithm available for use in third-party devices. Alternatively, an algorithm may be trained to detect certain activation words. In some embodiments, the activation word detector 312n runs multiple activation word detection algorithms on the received audio simultaneously (or substantially simultaneously). As noted above, different voice services (e.g. AMAZON's ALEXA®, APPLE's SIRI®, or MICROSOFT's CORTANA®) can each use a different activation word for invoking their respective voice service. To support multiple services, the activation word detector 312n may run the received audio through the activation word detection algorithm for each supported voice service in parallel.

The speech/text conversion components 312o may facilitate processing by converting speech in the voice input to text. In some embodiments, the electronics 312 can include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional voice activity services, which typically sample from a broad base of users and diverse requests that are not targeted to media playback systems.

FIG. 3F is a schematic diagram of an example voice input 328 captured by the NMD 320 in accordance with aspects of the disclosure. The voice input 328 can include an activation word portion 328a and a voice utterance portion 328b. In some embodiments, the activation word 557a can be a known activation word, such as “Alexa,” which is associated with AMAZON's ALEXA®. In other embodiments, however, the voice input 328 may not include an activation word. In some embodiments, a network microphone device may output an audible and/or visible response upon detection of the activation word portion 328a. In addition or alternately, an NMB may output an audible and/or visible response after processing a voice input and/or a series of voice inputs.

The voice utterance portion 328b may include, for example, one or more spoken commands (identified individually as a first command 328c and a second command 328e) and one or more spoken keywords (identified individually as a first keyword 328d and a second keyword 328f). In one example, the first command 328c can be a command to play music, such as a specific song, album, playlist, etc. In this example, the keywords may be one or words identifying one or more zones in which the music is to be played, such as the Living Room and the Dining Room shown in FIG. 1A. In some examples, the voice utterance portion 328b can include other information, such as detected pauses (e.g., periods of non-speech) between words spoken by a user, as shown in FIG. 3F. The pauses may demarcate the locations of separate commands, keywords, or other information spoke by the user within the voice utterance portion 328b.

In some embodiments, the media playback system 100 is configured to temporarily reduce the volume of audio content that it is playing while detecting the activation word portion 557a. The media playback system 100 may restore the volume after processing the voice input 328, as shown in FIG. 3F. Such a process can be referred to as ducking, examples of which are disclosed in U.S. patent application Ser. No. 15/438,749, incorporated by reference herein in its entirety.

FIGS. 4A-4D are schematic diagrams of a control device 430 (e.g., the control device 130a of FIG. 1H, a smartphone, a tablet, a dedicated control device, an IoT device, and/or another suitable device) showing corresponding user interface displays in various states of operation. A first user interface display 431a (FIG. 4A) includes a display name 433a (i.e., “Rooms”). A selected group region 433b displays audio content information (e.g., artist name, track name, album art) of audio content played back in the selected group and/or zone. Group regions 433c and 433d display corresponding group and/or zone name, and audio content information audio content played back or next in a playback queue of the respective group or zone. An audio content region 433e includes information related to audio content in the selected group and/or zone (i.e., the group and/or zone indicated in the selected group region 433b). A lower display region 433f is configured to receive touch input to display one or more other user interface displays. For example, if a user selects “Browse” in the lower display region 433f, the control device 430 can be configured to output a second user interface display 431b (FIG. 4B) comprising a plurality of music services 433g (e.g., Spotify, Radio by Tunein, Apple Music, Pandora, Amazon, TV, local music, line-in) through which the user can browse and from which the user can select media content for play back via one or more playback devices (e.g., one of the playback devices 110 of FIG. 1A). Alternatively, if the user selects “My Sonos” in the lower display region 433f, the control device 430 can be configured to output a third user interface display 431c (FIG. 4C). A first media content region 433h can include graphical representations (e.g., album art) corresponding to individual albums, stations, or playlists. A second media content region 433i can include graphical representations (e.g., album art) corresponding to individual songs, tracks, or other media content. If the user selections a graphical representation 433j (FIG. 4C), the control device 430 can be configured to begin play back of audio content corresponding to the graphical representation 433j and output a fourth user interface display 431d fourth user interface display 431d includes an enlarged version of the graphical representation 433j, media content information 433k (e.g., track name, artist, album), transport controls 433m (e.g., play, previous, next, pause, volume), and indication 433n of the currently selected group and/or zone name.

FIG. 5 is a schematic diagram of a control device 530 (e.g., a laptop computer, a desktop computer). The control device 530 includes transducers 534, a microphone 535, and a camera 536. A user interface 531 includes a transport control region 533a, a playback status region 533b, a playback zone region 533c, a playback queue region 533d, and a media content source region 533e. The transport control region comprises one or more controls for controlling media playback including, for example, volume, previous, play/pause, next, repeat, shuffle, track position, crossfade, equalization, etc. The audio content source region 533e includes a listing of one or more media content sources from which a user can select media items for play back and/or adding to a playback queue.

The playback zone region 533b can include representations of playback zones within the media playback system 100 (FIGS. 1A and 1B). In some embodiments, the graphical representations of playback zones may be selectable to bring up additional selectable icons to manage or configure the playback zones in the media playback system, such as a creation of bonded zones, creation of zone groups, separation of zone groups, renaming of zone groups, etc. In the illustrated embodiment, a “group” icon is provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone can be configured to play audio content in synchrony with the playback device(s) in the particular zone. Analogously, a “group” icon may be provided within a graphical representation of a zone group. In the illustrated embodiment, the “group” icon may be selectable to bring up options to deselect one or more zones in the zone group to be removed from the zone group. In some embodiments, the control device 530 includes other interactions and implementations for grouping and ungrouping zones via the user interface 531. In certain embodiments, the representations of playback zones in the playback zone region 533b can be dynamically updated as a playback zone or zone group configurations are modified.

The playback status region 533c includes graphical representations of audio content that is presently being played, previously played, or scheduled to play next in the selected playback zone or zone group. The selected playback zone or zone group may be visually distinguished on the user interface, such as within the playback zone region 533b and/or the playback queue region 533d. The graphical representations may include track title, artist name, album name, album year, track length, and other relevant information that may be useful for the user to know when controlling the media playback system 100 via the user interface 531.

The playback queue region 533d includes graphical representations of audio content in a playback queue associated with the selected playback zone or zone group. In some embodiments, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a play back device in the play back zone or zone group to find and/or retrieve the audio item from a local audio content source or a networked audio content source, possibly for playback by the playback device. In some embodiments, for example, a playlist can be added to a playback queue, in which information corresponding to each audio item in the playlist may be added to the playback queue. In some embodiments, audio items in a play back queue may be saved as a playlist. In certain embodiments, a playback queue may be empty, or populated but “not in use” when the playback zone or zone group is playing continuously streaming audio content, such as Internet radio that may continue to play until otherwise stopped, rather than discrete audio items that have playback durations. In some embodiments, a playback queue can include Internet radio and/or other streaming audio content items and be “in use” when the playback zone or zone group is playing those items.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped.

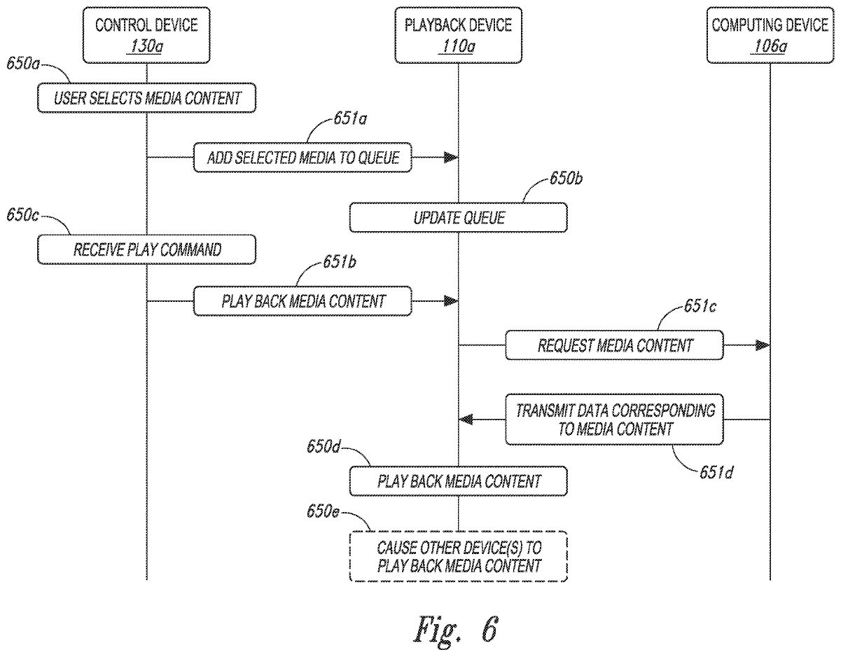

FIG. 6 is a message flow diagram illustrating data exchanges between devices of the media playback system 100 (FIGS. 1A-1M).

At step 650a, the media playback system 100 receives an indication of selected media content (e.g., one or more songs, albums, playlists, podcasts, videos, stations) via the control device 130a. The selected media content can comprise, for example, media items stored locally on or more devices (e.g., the audio source 105 of FIG. 1C) connected to the media playback system and/or media items stored on one or more media service servers (one or more of the remote computing devices 106 of FIG. 1B). In response to receiving the indication of the selected media content, the control device 130a transmits a message 651a to the playback device 110a (FIGS. 1A-1C) to add the selected media content to a playback queue on the playback device 110a.

At step 650b, the playback device 110a receives the message 651a and adds the selected media content to the playback queue for play back.

At step 650c, the control device 130a receives input corresponding to a command to play back the selected media content. In response to receiving the input corresponding to the command to play back the selected media content, the control device 130a transmits a message 651b to the playback device 110a causing the playback device 110a to play back the selected media content. In response to receiving the message 651b, the playback device 110a transmits a message 651c to the first computing device 106a requesting the selected media content. The first computing device 106a, in response to receiving the message 651c, transmits a message 651d comprising data (e.g., audio data, video data, a URL, a URI) corresponding to the requested media content.

At step 650d, the playback device 110a receives the message 651d with the data corresponding to the requested media content and plays back the associated media content.

At step 650e, the playback device 110a optionally causes one or more other devices to play back the selected media content. In one example, the playback device 110a is one of a bonded zone of two or more players (FIG. 1M). The playback device 110a can receive the selected media content and transmit all or a portion of the media content to other devices in the bonded zone. In another example, the playback device 110a is a coordinator of a group and is configured to transmit and receive timing information from one or more other devices in the group. The other one or more devices in the group can receive the selected media content from the first computing device 106a, and begin playback of the selected media content in response to a message from the playback device 110a such that all of the devices in the group play back the selected media content in synchrony.

### IV. Wireless Power Transfer Devices and Associated Systems and Methods

Audio playback devices capable of receiving wireless power provide several distinct advantages over conventional wired devices. For example, there is no need to hide unsightly power cords by routing them through a wall or underneath furniture. Wireless power transfer may also allow a user to reposition devices more easily around a home or room without needing to disconnect or re-route power cords. To enable this functionality, one or more wireless power transmitter devices can be provided in the vicinity of an audio playback device having a wireless power receiver therein. Such a transmitter device can include another playback device (e.g., a soundbar, subwoofer, or any playback device having a wired power connection), or a non-playback device (e.g., a power hub that provides wireless power to the playback device without itself driving audio output). In some examples, one or more playback devices can include both a wireless power receiver and a wireless power transmitter, such that these devices may be used in either configuration, or in some instances may be used in both configurations simultaneously (e.g., as a “relay” in which a device receives wireless power from an external transmitter device and transmits wireless power to an external receiver device). In some instances, a plurality of such playback devices can transfer wireless power among one another in a mesh configuration, with the particular device-to-device transmission being selected to provide the desired power levels, device performance, and user experience.

As used herein, a “wireless power transmitter” or “transmitter device” includes any device (or component(s) of a device) capable of sending wireless power that can be received and recovered by a suitable receiver device. Similarly, a “wireless power receiver” or “receiver device” includes any device (or component(s) of a device) capable of receiving wireless power from a remote transmitter device and utilizing that power to operate one or more components of the receiver device (e.g., to power at least one amplifier of a playback device). In various examples, a single playback device (or other device) can be both a wireless power transmitter and a wireless power receiver, while in other examples a particular device may be only a transmitter device or only a receiver device.

In various examples disclosed herein, such wireless power transfer can include mid- or long-range wireless power transfer. As used herein, mid- and long-range wireless power transfer includes wireless power transfer over a distance of greater than about 10 cm, or in some examples greater than about 50 cm or greater than about 1 m. For example, in some instances a wireless power transmitter device and a wireless power receiver device can be separated from one another by at least about 10 cm, at least about 50 cm, or at least about 1 m during wireless power transfer.

As noted elsewhere herein, such mid- or long-range wireless power transfer technologies include radiative techniques (e.g., lasers, radio waves, microwaves, or other such propagation of electromagnetic radiation from the transmitter device towards the receiver device). In various examples, the wireless power receiver in such instances can include a photovoltaic cell, a diode, an antenna (e.g., a rectenna), or other suitable hardware that can convert electromagnetic radiation into electrical energy. Similarly, the wireless power transmitter in such instances can include an optical source such as a laser, a microwave source, an antenna (e.g., directional antennas, phased array antennas, etc.), or other suitable source of electromagnetic radiation.

Additionally or alternatively, such mid- or long-range wireless power transmission can include non-radiative transmission such as electromagnetic coupling (e.g., inductive coupling, resonant inductive coupling, capacitive coupling, resonant capacitive coupling, magnetodynamic coupling, etc.). In such instances, both the wireless power transmitter and the wireless power receiver can include electrically conductive coils (e.g., in the case of inductive coupling), electrodes (e.g., in the case of capacitive coupling), or rotating armatures carrying magnets thereon (e.g., in the case of magnetodynamic coupling).

a. Suitable Wireless Power Transfer Device Components

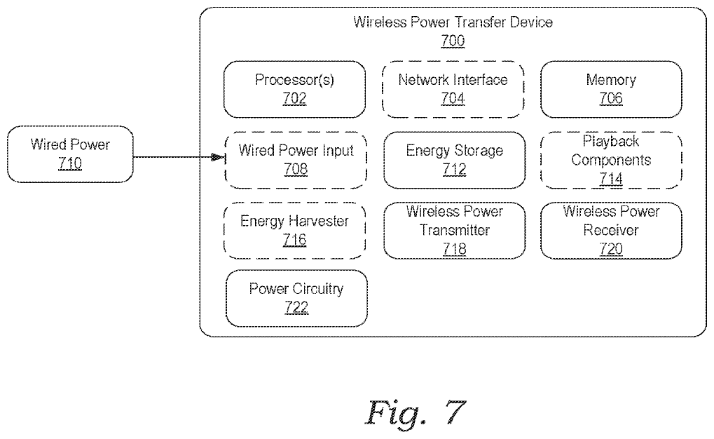

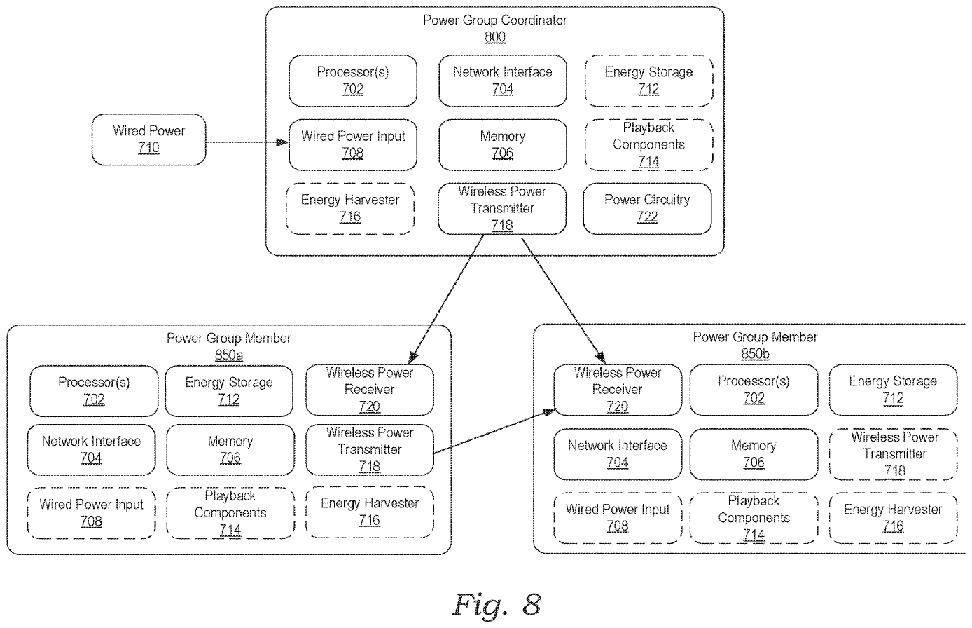

FIG. 7 is a schematic block diagram of a wireless power transfer (WPT) device 700. In some examples, the device 700 can be coupled to, integrated into, or included within a playback device (e.g., playback device 110a of FIG. 1C), an NMD (e.g., NMD 120a of FIG. 1F), or other suitable device.

Referring to FIG. 7, the WPT device 700 includes one or more processors 702, a network interface 704, and memory 706. These can be similar to, identical to, or include, processors 112a, network interface 112d, and memory 112b described above with respect to FIGS. 1C and 1F. In various examples, the wireless power transfer device 700 can include any or all of the features of playback device 110a or NMD 120a described previously herein. In some examples, the network interface 704 can include one or more transceivers that are configured to communicate via at least one WIFI network, and/or at least one BLUETOOTH network.

WPT device 700 optionally includes a wired power input port 708 that is configured to be electrically coupled to wired power 710 (e.g., via 110/220V wall power, a USB-C charger, etc.), such as an AC power port or a USB port (e.g., a USB TYPE-A port, a USB TYPE-B port, a USB TYPE-C port, etc.). The power input port 708 can be coupled (e.g., via cable) directly to a household power outlet (e.g., to receive alternating current (AC) power) or indirectly via a power adapter (e.g., a device that converts the AC power from the household power outlet to direct current (DC) power). In some examples, the wired power input port 708 is omitted, and the WPT device 700 operates solely on the basis of power received wirelessly from external transmitter device(s) and/or energy generated via energy harvester(s) 716.

The WPT device 700 further includes an energy storage component 712, which can take the form of a rechargeable battery, a capacitor, a supercapacitor, or any other suitable component that can store energy. The energy storage component 712 can be configured to store energy and to facilitate operation of the device (e.g., powering one or more amplifiers of a playback device). In this regard, the energy storage component 712 can be a battery that has a chemistry that facilitates recharging the battery, such as lithium-ion (Li-ion), nickel-metal hydride (NiMH), nickel-cadmium (NiCd), etc. The battery can be sized such that the processor(s) 702 and other components of the WPT device 700 can operate on battery power alone for an extended amount of time without the battery needing to be recharged. For example, the battery can have a 20 watt-hours (Wh) capacity that facilitates continuous playback of audio for at least 4 hours on battery power alone. The battery can be charged using power from one or more other components in the device 700 (e.g., wired power input port 708, wireless power receiver 720, energy harvester 716, etc.).

As noted previously, in some examples, the wireless power device 700 can include audio playback components 714 (e.g., one or more transducers, audio processing circuitry, microphones, voice processing circuitry, etc.), and as such the WPT device 700 can include or be part of an audio playback device or a network microphone device as described elsewhere herein. In various examples, such an audio playback device can be a soundbar, a subwoofer, a headphone device, a hearable device, a portable audio playback device, an architectural playback device, or a video playback device

The WPT device 700 optionally includes one or more energy harvesters 716. Energy harvesters 716 may include those devices configured to derive power from energy sources in the environment (e.g., solar energy, thermal energy, wind energy, salinity gradients, kinetic energy, sound energy, etc.). For example, the energy harvesters 716 can include one or more photovoltaic cells configured to convert received light into a voltage. Any of a variety of energy harvesters 716 may be included in the WPT device 700. Examples of such energy harvesters include photovoltaic cells, thermoelectric generators, micro wind turbines, piezoelectric crystals, electroacoustic transducers, and kinetic energy harvesters.

The WPT device additionally includes a wireless power transmitter 718, a wireless power receiver 720, and power circuitry 722. In operation, the WPT device 700 can receive wireless power from an external transmitter device via the receiver 720, and can transmit wireless power to an external receiver device via the transmitter 718, with the power circuitry 722 controlling some or all of the functions associated with these operations.

The wireless power transmitter 718 can include any component or combination of components capable of transmitting wireless power to an external wireless power receiver device. Such wireless power transfer can include mid- or long-range wireless power transfer, for example being configured to provide effective power transfer with the transmitter and receiver separated from one another by a distance of greater than about 10 cm, or in some examples greater than about 50 cm or greater than about 1 m. In various examples, the wireless power transmitter 718 can transmit power via radiative techniques such as using lasers, radio waves, microwaves, or other such techniques involving propagation of electromagnetic radiation from the transmitter device towards the receiver device. In various embodiments, such electromagnetic radiation may be directional (e.g., directed towards one or more receiver devices) or omnidirectional (e.g., radiating in substantially all directions from the wireless power transmitter 718). In various examples, the wireless power transmitter 718 in such instances can include an optical source such as a laser, a microwave source, an antenna (e.g., directional antennas, phased array antennas, etc.), or any other source of electromagnetic radiation. In some instances, the wireless power transmitter 718 can include one or more steering components configured to direct, focus, or steer wireless power. Such steering components can include, for example, one or more lenses, mirrors, directional antennas, or other suitable components.

Additionally or alternatively, the wireless power transmitter 718 can be configured to transmit wireless power using non-radiative techniques such as electromagnetic coupling (e.g., inductive coupling, resonant inductive coupling, capacitive coupling, resonant capacitive coupling, magnetodynamic coupling, etc.). In such instances, the wireless power transmitter 718 can include electrically conductive coils (e.g., in the case of inductive coupling), electrodes (e.g., in the case of capacitive coupling), rotating armatures carrying magnets thereon (e.g., in the case of magnetodynamic coupling), or any other suitable structure capable of receiving power wirelessly via electromagnetic coupling.

The wireless power receiver 720 can include any component or structure configured to receive power wirelessly (e.g., via inductance, resonance, radiation, etc.) from an external wireless transmitter device. As noted previously, such wireless power transfer can include mid- or long-range wireless power transfer, for example being configured to provide effective power transfer with the transmitter and receiver separated from one another by a distance of greater than about 10 cm, or in some examples greater than about 50 cm or greater than about 1 m. In various examples, the wireless power receiver 720 can receive power via radiative techniques such as lasers, radio waves, microwaves, or other such techniques involving propagation of electromagnetic radiation from the transmitter device towards the receiver device. The wireless power receiver 720 in such instances can include an optical receiver such as a diode, a photovoltaic cell, an antenna (e.g., a rectenna), or other suitable hardware that can convert electromagnetic radiation into electrical energy.

Additionally or alternatively, the wireless power receiver 720 can be configured to receive wireless power using non-radiative techniques such as electromagnetic coupling (e.g., inductive coupling, resonant inductive coupling, capacitive coupling, resonant capacitive coupling, magnetodynamic coupling, etc.). In such instances, the wireless power receiver 720 can include electrically conductive coils (e.g., in the case of inductive coupling), electrodes (e.g., in the case of capacitive coupling), a rotating armature carrying a magnets thereon (e.g., in the case of magnetodynamic coupling), or any other suitable structure capable of receiving power wirelessly via electromagnetic coupling.

With continued reference to FIG. 7, the WPT device 700 can include power circuitry 722 configured to receive power from the energy storage component 712, the wired power input 708, and/or the wireless power receiver 720, and, using the power obtained therefrom, drive an amplifier and/or a electroacoustic transducer with an audio output based on source audio. The power circuitry 722 can be configured to perform any of a variety of power-related tasks including, for example, one or more of the following: (1) power conversion (e.g., AC-AC conversion, AC-DC conversion, DC-AC conversion, and/or DC-DC conversion); (2) power regulation; (3) battery charging; and/or (4) power monitoring (e.g., battery monitoring). Examples of electrical components that may be integrated into the power circuitry 722 include transformers, rectifiers, inverters, converters, regulators, battery chargers, and/or power management integrated circuits (PMICs). In some examples, such power circuitry 722 can be integrated into either or both the wireless power transmitter 718 and the wireless power receiver 720.

In some examples, the power circuitry 722 can include battery circuitry that facilitates monitoring a state of a battery. In these examples, the battery circuitry can identify battery state information that includes information regarding one or more of the following battery states: a state-of-charge (SoC), temperature, age, and/or internal impedance. The battery circuitry can communicate the battery state information to, for example, the processor 702.

The power circuitry 722 can include regulation circuitry that facilitates converting a variable amount of voltage (e.g., a variable voltage from a battery, a variable voltage from an energy harvester, etc.) to a stable DC voltage. For example, the regulation circuitry can include switching regulator circuitry such as buck, boost, buck-boost, flyback, resonant, etc. switching regulator circuitry. The regulation circuitry can include one or more linear voltage regulators such as low-dropout (LDO) regulators. The regulation circuitry can be configured to output one or more fixed DC voltages (e.g., ±5V, ±12V) or AC voltages.

b. Wireless Power Group Examples

FIG. 8 shows interactions among a power group, which includes a plurality of WPT devices that can transfer power and/or data among one another. In the example shown in FIG. 8, the group includes a power group coordinator 800, and first and second power group members 850a and 850b. Each of the power group coordinator 800 and the power group members 850a and 850b can include some or all of the components described above with respect to the WPT device 700 of FIG. 7. In some examples, some or all of these devices can include or be audio playback devices. Although the illustrated group includes three devices, in various examples there may be one, two, four, five, or many more power group members (not shown).

As used herein, a “power group” can include two or more devices that are configured to wirelessly transfer power therebetween. In the illustrated example, the coordinator 800 transmits wireless power (e.g., via wireless power transmitter 718) to each of the first power group member 850a and the second power group member 850b. Additionally, the first group member 850a transmits wireless power to the second power group member 850b. In alternative examples, the power group coordinator 800 may transmit wireless power to fewer than all members of the wireless power group, with one or more group members 850 transmitting power to other group members 850 such that each device of the group receives or transmits wireless power to or from at least one other device of the group.

In the illustrated example, the power group coordinator 800 does not include a wireless power receiver 720, and it is connected to wired power 710. However, in other instances the power group coordinator 800 may have no connection to wired power 710, and may itself only be powered via wireless power transmission and/or energy harvesting. In some examples, one or more of the power group members 850 may be connected to wired power instead of or in addition to receiving wireless power from other group members.

As used herein, a “power group coordinator” can include a wireless power transfer device that is configured to transmit instructions to one or more power group members to initiate, cease, or modulate wireless power transmission therebetween. For example, a power group coordinator may cause the first power group member 850a to initiate wireless power transmission to the second power group member 850b. As described in more detail elsewhere herein, in some examples wireless power transmission may be initiated, ceased, or modified based on a number of parameters (e.g., a battery level of a device, a level or rate or wireless power received at a device, audio playback levels, etc.). In some examples, such parameters may be determined by or transmitted to the power group coordinator 800, which may then determine any appropriate modifications to wireless power transfer within the group, and may transmit instructions to group members accordingly.

In at least some instances, there may be no power coordinator. In such cases, each wireless power transfer device may independently determine whether, how, and when to transmit or receive wireless power from any external transmitter or receiver devices.

As noted previously, in some examples a plurality of audio playback devices can be grouped together for synchronous audio playback (e.g., as a bonded zone). In such instances, one of the playback devices may be a coordinator of the group, and may transmit and receive timing information from one or more other devices in the group. In various examples, the power group may be identical to the audio playback group. Alternatively, the power group may differ at least in part from any audio playback grouping. In at least some examples, the power group coordinator 800 may also serve as an audio playback group coordinator. In such cases, the power group coordinator 800 may transmit timing data or other information to group members via a wireless network and/or via data incorporated into the wireless power signals, as described in more detail elsewhere herein. Alternatively, the power group coordinator 800 and the audio playback group coordinator may be different devices. In still other examples, the power group may be formed without any audio playback grouping taking place, in which case there may be no audio playback group coordinator.

### V. Examples of Proximity-Based Power Management for Audio Playback Devices

As noted previously, in some instances it can be useful to conserve power for portable audio playback devices, such as by offloading at least a portion of the audio content (e.g., some or all of the low-frequency audio content) to one or more nearby playback devices. This offloading may occur automatically based on certain power parameters, device parameters, or proximity parameters, or alternatively may occur when the user groups the portable playback device with one or more other playback devices. In the case of automatic grouping, this may occur when the system detects that the portable playback device is within a certain, predetermined vicinity of another playback device (whether another portable playback device or a stationary plug-in playback device).

As described in more detail below, the particular schemes for modifying the audio output of the portable playback device (e.g., offloading at least some audio playback responsibilities to another nearby playback device) can be based on the proximity of the devices (e.g., the devices are within a predetermined distance for at least a threshold amount of time), the acoustic efficiency profile of the various playback devices, or the current volume output of the nearby playback device (e.g., only offloading lower frequency outputs to the nearby playback device when that playback device is playing back audio loud enough that a user would not immediately notice the change). Such power-optimization schemes may also be based at least in part on the battery temperature of the portable playback device, as the rate of power consumption may vary with temperature. Moreover, in addition to modifying the audio output, other functions of the portable playback device can be modified or restricted based on power levels (e.g., disabling microphones, Bluetooth antenna, lights, etc.).

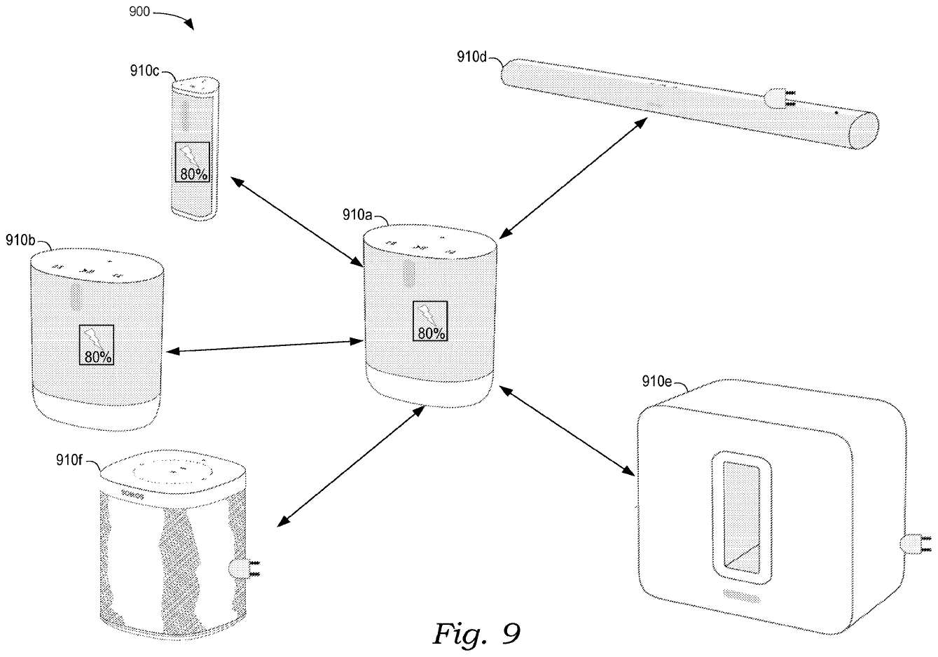

FIG. 9 is a schematic illustration of a media playback system 900 including portable playback devices with proximity-based power management capabilities in accordance with the disclosed technology. As shown, the media playback system 900 includes a first portable playback device 910a, a second portable playback device 910b, a third portable playback device 910c (e.g., an ultraportable playback device), and stationary plug-in playback devices 910d (e.g., a soundbar), 910e (e.g., a subwoofer), and 910f (e.g., a relatively compact all-in-one playback device). While the illustrated playback devices are shown by way of example, any number and type of playback devices may be included within such a media playback system 900. As used herein, “portable playback devices” include playback devices having an internal energy storage (i.e., power storage), such as a rechargeable battery, an ultracapacitor, etc., that allows the device to be operational even when not coupled to an external power source (e.g., a charging stand, a wire connected to a power outlet, etc.). In contrast, “stationary plug-in playback devices” include playback devices that cannot operate without being coupled to an external power source (e.g., a power cord connected to a wall outlet, a power stand, etc.). Such devices are stationary in the sense that they typically remain in one place, but of course may be unplugged and moved about the environment from time to time.

With reference to FIG. 9, in various examples the media playback system 900 can vary the playback responsibilities of some or all of the portable playback devices 910a, 910b, and 910c depending on the particular conditions of the system 900 or the particular devices 910a-910f. In some instances, audio content can be played back via the first portable playback device 910a while in a first operating mode. This can represent the “normal” operating mode of the first portable playback device 910a, in which the device operates without any constraints due to energy storage levels. Under certain conditions, the media playback system 900 can transition between the first operating mode to a second operating mode in which at least a portion of the audio content that would otherwise have been played back by the first portable playback device 910a is offloaded to one or more of the other playback devices 910b-910f. Whether and how such audio content is offloaded to one or more other playback devices can depend on a power parameter, a proximity parameter, a grouping parameter, the particular audio content being played back, playback volume, or any other suitable parameter. For example, the power parameter can include or relate to the energy storage level (e.g., battery charge level) of the first portable playback device 910a and/or the other devices, the acoustic efficiency profile of the various playback devices, the battery temperature of the first portable playback device 910a or other devices, a rate of power consumption of the first portable playback device 910a or the other portable playback devices, or a battery “health” of an individual portable playback device. In some instances, a power parameter can relate to a level or rate or power generation (e.g., via on-board energy harvesters) or wireless power receipt (e.g., from a wireless power transmission device as described elsewhere herein). The proximity parameter can include or relate to a proximity between the first portable playback device 910a and any of the other playback devices, optionally including a determination that particular devices are within a predetermined vicinity of one another for a predetermined threshold amount of time. The grouping parameter can include or relate to whether or not the first portable playback device 910a has been grouped with any other playback devices for synchronous playback. The battery health parameter can include or relate to a number or count of the charging cycles that a playback device's battery has undergone. In some embodiments, a portable player may be selected for full-frequency playback over another player based on whether a player is closer, or substantially closer to end of life than the other. For example, a player that has undergone 2,000 or more charging cycles may be selected over another player that has undergone fewer than 2,000 charging cycles, or far fewer charging cycles e.g., only 100 charging cycles.

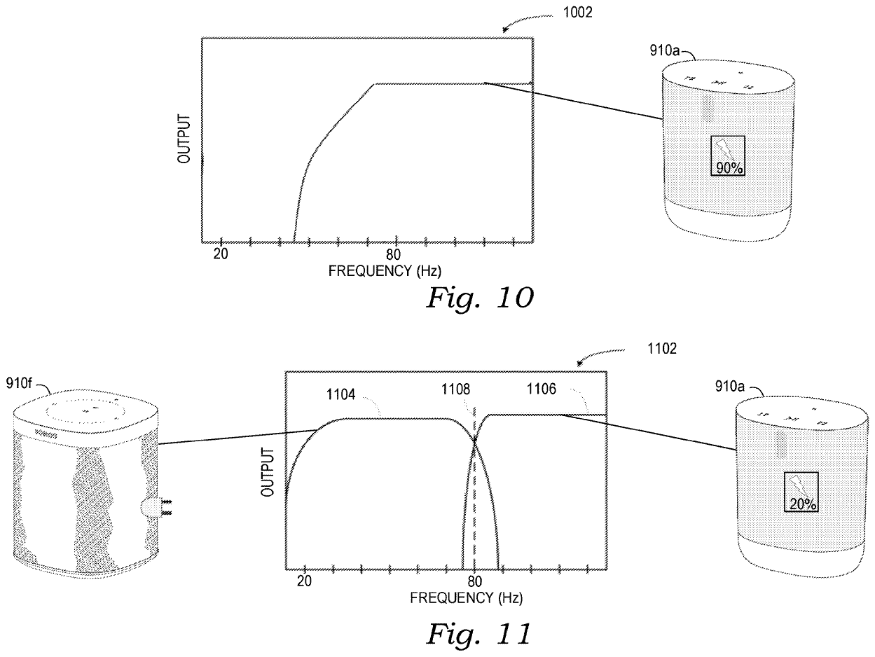

FIG. 10 illustrates example frequency response curve 1002 for a portable playback device 910a operating in a first mode. In this configuration, the portable playback device 910a can have substantially full-frequency playback responsibilities. This can represent the “normal” operating mode of the portable playback device 910a, when the power level is sufficiently high (e.g., 90% of charge, as shown here). As noted previously, as the power level of the portable playback device 910a falls, it can be useful to transition the portable playback device 910a from a first mode to a second mode. In some instances, while in the first mode, the portable playback device 910a assumes substantially full-frequency playback responsibilities, and while in the second mode, the portable playback device 910a assumes different playback responsibilities (e.g, offloading at least some low-frequency audio content to one or more nearby playback devices).

FIG. 11 illustrates example frequency response curves 1102 for a portable playback device 910a and a stationary plug-in playback device 910f operating in a second mode. Although this example relates to a portable playback device 910a that is disconnected from power and a stationary plug-in playback device 910f that is connected to power, this approach can be extended to scenarios in which the stationary plug-in playback device 910f is replaced with a portable playback device that is connected to power (e.g., via a charging base, charging cradle, charging cable, wirelessly charged, etc.).

While in the second mode, the frequency response 1104 corresponds to the audio output of the stationary plug-in playback device 910f, and the frequency response 1106 corresponds to the audio output of the portable playback device 910a. In the example illustrated in FIG. 11, a crossover or threshold frequency 1108 is approximately 80 Hz, though any suitable threshold frequency can be used. As shown, the frequency response 1104 of the stationary plug-in playback device 910f is primarily below the threshold frequency 1108, and the frequency response 1106 of the portable playback device 910a is primarily above the threshold frequency 1108.

In the illustrated example, the stationary plug-in playback device 910f outputs audio with more bass-heavy content (e.g., higher output below the threshold frequency 1108) than the audio output by the portable playback device 910a (which has a higher output above the threshold frequency 1108). Because bass-heavy audio content can consume more power during playback than higher frequency audio content, offloading bass-heavy audio content to the stationary plug-in playback device 910f can significantly decrease the power consumption of the portable playback device 910a. Although the threshold frequency 1108 in this example is about 80 Hz, in various examples the threshold frequency can be about 40, 50, 60, 70, 80, 90, 100, 110, 120, 130, 140, 150, 160, 170, 180, 190, or 200 Hz. In some examples, the threshold frequency can vary over time based on a proximity parameter and/or a power parameter.

According to some examples, while in the second mode the stationary plug-in playback device 910f may play back only audio content below the predetermined threshold frequency. This may be particularly useful in masking the fact that the stationary plug-in playback device 910f is augmenting audio that is being played back via the portable playback device 910a. Because bass content is more omnidirectional than higher frequency audio content, bass content provided by a nearby but still separately located stationary plug-in playback device 910f may not be consciously detectable by the user listening to audio via the portable playback device 910a.

In some examples, in transitioning to the second mode, the portable playback device 910a can be automatically grouped or bonded with the stationary plug-in playback device 910f for synchronous playback. This automatic grouping or bonding can be visible to the user (e.g., indicated via a user interface on a controller device) or invisible to the user (e.g., not indicated via the user interface on a controller device).

Although this example illustrates a relatively simple cross-over configuration, in which the stationary plug-in playback device 910f outputs audio primarily below the threshold frequency 1108 and the portable playback device 910a outputs audio primarily above the threshold frequency 1108, other approaches are possible. For example, the particular spectral calibration profile of the portable playback device 910a and/or of the stationary plug-in playback device 910f can vary between the first mode and the second mode. Moreover, the particular spectral calibration profile adopted by the portable playback device 910a can vary depending on the particular playback device that is being used to augment its output in the second mode. For instance, if the stationary plug-in playback device 910f has very high bass-output capabilities, the portable playback device 910a may adopt a particular spectral calibration profile while in the second mode (e.g., offloading substantially all bass output responsibilities). However, if the stationary plug-in playback device 910f were instead a device with a smaller form factor and lower bass-output capabilities, the portable playback device 910a may adopt a different spectral calibration profile while in the second mode (e.g., offloading a smaller proportion of the bass output responsibilities to the nearby stationary plug-in playback device).

In some instances, while in the second mode, the portable playback device 910a may continue to output some audio below the threshold frequency, although at a lower level than while operating in the first mode. Moreover, the threshold frequency itself may vary dynamically depending on a variety of factors, including the proximity of the two devices, the power level of the portable playback device 910a, the acoustic efficiency of both playback devices, the temperature of the battery, etc.

Optionally, the playback responsibilities of the stationary plug-in playback device 910f can vary as the proximity of the two devices changes. For example, as the portable playback device 910a is moved further away from the stationary plug-in playback device 910f, the audio output via the stationary plug-in playback device 910f can fade out, rather than abruptly terminating once a predetermined threshold distance is exceeded.

As noted above, the portable playback device 910a can transition between the first mode and the second mode based at least in part on one or more proximity parameters and/or one or more power parameters. The proximity parameter can include or be based on a determined distance between the portable playback device 910a and other playback device(s) within the environment, whether portable unplugged devices, portable plugged-in devices, stationary plug-in devices, or otherwise. For example, the proximity parameter can include an indication that another playback device is within a predetermined distance of the portable playback device 910a. In various examples, the indication that one or more other playback devices are in proximity to the portable playback device can be based on one or more localization signals exchanged between the portable playback device and the other playback device(s), and/or localization signals between these devices and other network devices within the environment (e.g., a controller device, other playback devices, etc.). Additional details and examples of determining relative positions of playback devices within an environment can be found in commonly owned U.S. Application No. 62/261,876, filed Sep. 30, 2021, titled “Spatial Mapping of Media Playback System Components,” which is hereby incorporated by reference in its entirety and included as an Appendix to this application.

In various examples, the power parameter(s) can include an energy storage level of the portable playback device 910a. For example, if the energy storage level falls below a predetermined first threshold, the portable playback device 910a can transition from the first mode to the second mode. If the portable playback device 910a is then re-charged (e.g., placed on its charging base), the portable playback device 910a may transition from the second mode back to the first mode in response to the power level of the portable playback device 910a rising above a predetermined second threshold. These thresholds can be the same (e.g., both transitions occur at 20% charge), or may differ (e.g., transition to second mode when energy storage falls below 20%, but transition back to first mode only when energy storage rises above 60%). Either or both threshold energy storages can be, for example, about 5%, 10%, 15%, 20%, 25%, 30%, 35%, 40%, 45%, 50%, 55%, 60%, 65%, 70%, 75%, 80%, 85%, 90%, or 95% of the full charge capacity of the portable playback device energy storage.

In some examples, the playback devices can operate in a manner to achieve longer battery life (e.g., maximizing battery life), such as by periodically switching between which playback device is designated to playback low-frequency audio content. For instance, if two playback devices each begin with battery storage levels at 50%, switching between which device plays back low-frequency content (while the other device does not play back such low-frequency content, or plays back a lesser proportion of such low-frequency content), a longer total playtime can be achieved. The table below illustrates an example of such a switching scheme based on charge levels. As shown in the table below, at time T1, playback device A is designated to output low-frequency content, while playback device B does not. Due to this difference, the charge level of playback device A drops faster than the charge level of play back device B. Later, at time T7, when playback device A has a 44% charge level compared to a 47% charge level of playback device B, the designation switches such that playback device B begins outputting low-frequency content while playback device A does not. Due to this transition, the charge level of playback device B begins to drop faster than the charge level of playback device A. Later, at time T20, the designation switches again. This process can repeat until the total charge level is depleted, until one or both devices is connected to a power source, or other suitable termination event. Although this example is described in terms of one device playing back low-frequency content while the other does not, any suitable variation in playback responsibilities between the two devices that results in differential charge-depletion rates can be used. For example, relative amounts of low-frequency content can be varied between the two devices according to such a switching scheme.

| | | Playback | Playback |
|---|---|---|---|
| | | device A | device B |
| Event | Time | charge level | charge level |
| Playback device A designated to | T1 | 50% | 50% |
| output low-frequency content | | | |
| | T2 | 49% | 50% |
| | T3 | 48% | 49% |
| | T4 | 47% | 49% |
| | T5 | 46% | 48% |
| | T6 | 45% | 48% |
| Playback device B designated to | T7 | 44% | 47% |
| output low-frequency content; | | | |
| playback device A ceases | | | |
| outputting low-frequency content | | | |
| | T8 | 43% | 46% |
| | T9 | 43% | 45% |
| | T10 | 42% | 44% |
| | T11 | 42% | 43% |
| | T12 | 41% | 42% |
| | T13 | 41% | 41% |
| | T14 | 40% | 40% |
| | T15 | 40% | 39% |
| | T16 | 39% | 38% |
| | T17 | 39% | 37% |
| | T18 | 38% | 36% |
| | T19 | 38% | 35% |
| Playback device A designated to | T20 | 37% | 34% |
| output low-frequency content; | | | |
| playback device B ceases | | | |
| outputting low-frequency content | | | |

FIG. 12 illustrates example frequency response curves for first and second portable playback devices operating in first and second modes. In various examples, the first portable playback device 910a and the second portable playback device 910b may be grouped or bonded together for synchronous audio playback (e.g., whether automatically or by a user), and/or the first and second portable playback devices 910a and 910b may be in close proximity to one another (e.g., within a predetermined distance of one another as described previously), even if not initially grouped or bonded together for synchronous playback.

The plot 1200 illustrates an example frequency response 1202 for either or both of the first and second portable playback devices 910a and 910b while operating in the first mode. As indicated previously, the first mode can reflect a “normal” operating mode in which the portable playback device has sufficient energy storage levels to maintain its normal operating conditions. As the energy storage level falls (and/or based on other parameters), the portable playback device(s) can transition to the second mode to conserve power. In the example shown in FIG. 12, the second portable playback device 910b has a lower energy storage level (40%), which causes the second portable playback device 910b to transition from the first mode to a second mode.

As shown in plot 1204, in the second mode audio output via the second portable playback device 910b is modified, such that the frequency response shifts from frequency response 1202 (which corresponds to the first operating mode) to frequency response 1206. This adjusted frequency response 1206 is shifted higher, such that the second portable play back device 910b outputs less low-frequency audio content than while in the first mode. As noted previously, reducing the output of lower-frequency audio content can conserve power for the second portable playback device 910b, thereby extending the total playback time before the energy storage is depleted.

In some instances, the second portable playback device 910b can transition to the second mode once its energy storage level falls below a predetermined threshold, or once its energy storage level falls below that of the first portable playback device 910a, for instance if the first portable playback device 910a and the second portable playback device 910b are playing back audio synchronously. Optionally, the frequency response of the first portable playback device 910a can also shift, though in an opposite manner, so as to output a greater proportion of lower-frequency audio content. This shift can offset the reduction in low-frequency output via the second portable playback device 910b, although this may result in a higher rate of power consumption for the first portable playback device. In yet another example, while in the second mode the first portable playback device 910a may adjust its audio output without the second portable playback device 910b modifying its own output.

In some instances, the first portable playback device 910a can continue to output a higher proportion of low-frequency audio content until the energy storage levels of the two devices are equal or within a predetermined threshold range of one another. In some instances, the various playback responsibilities of the two devices 910a and 910b can be modified dynamically over time to achieve a similar or identical power consumption rate or projected time to a target energy storage level (e.g., both devices will reach 20% charge at approximately the same time, or both devices will fully deplete their energy stores at approximately the same time). For example, the spectral calibration profiles of one or both devices can be modified over time (e.g., with different threshold frequencies and/or different frequency response curves over time). By adjusting playback responsibilities to reach equilibrium between energy storage levels of the two playback devices, the system can avoid the undesirable scenario in which one portable playback device loses power and drops out completely while the other continues to play back audio content.

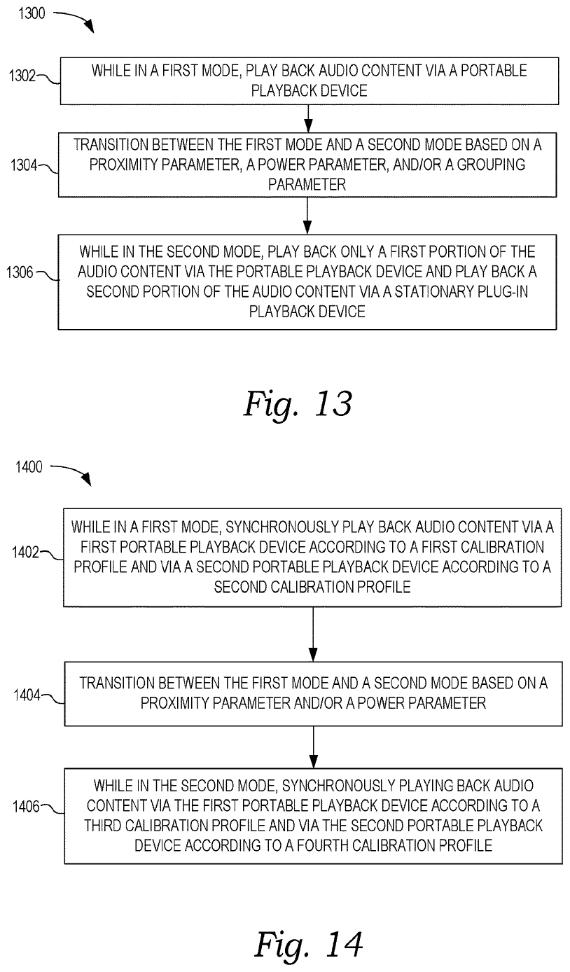

FIGS. 13 and 14 illustrate example methods for proximity-based power management in accordance with the present technology. The methods 1300 and 1400 can be implemented by any of the devices described herein, or any other devices now known or later developed. Various embodiments of the methods 1300 and 1400 include one or more operations, functions, or actions illustrated by blocks. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation.

In addition, for the methods 1300 and 1400 and for other processes and methods disclosed herein, the flowcharts show functionality and operation of possible implementations of some embodiments. In this regard, each block may represent a module, a segment, or a portion of program code, which includes one or more instructions executable by one or more processors for implementing specific logical functions or steps in the process. The program code may be stored on any type of computer readable medium, for example, such as a storage device including a disk or hard drive. The computer readable medium may include non-transitory computer readable media, for example, such as tangible, non-transitory computer-readable media that stores data for short periods of time like register memory, processor cache, and Random-Access Memory (RAM). The computer readable medium may also include non-transitory media, such as secondary or persistent long-term storage, like read only memory (ROM), optical or magnetic disks, compact disc read only memory (CD-ROM), for example. The computer readable media may also be any other volatile or non-volatile storage systems. The computer readable medium may be considered a computer readable storage medium, for example, or a tangible storage device. In addition, for the methods and for other processes and methods disclosed herein, each block in FIGS. 13 and 14 may represent circuitry that is wired to perform the specific logical functions in the process.

FIG. 13 illustrates an example method 1300 in accordance with examples of the present technology. As described below, the method 1300 involves playing back audio content via a portable playback device in accordance with two different modes. In the first mode, the portable playback device can play back some or all of the audio content, while in a second mode, the portable playback device may play back less than all of the audio content while a stationary plug-in playback device (e.g., a nearby, plugged-in playback device) can play back a second portion of the audio content. In this manner, the stationary plug-in playback device can supplement or augment the playback responsibilities of the portable playback device. This can be useful to, for example, manage the power level, power consumption rate, and/or audio playback quality of the portable playback device and/or other playback devices within the media playback system.

The method 1300 begins at block 1302, which involves playing back audio content via a portable playback device while in a first mode. For example, the portable playback device can receive audio content (e.g., from an external source via a network interface, via another playback device of the same media playback system, a local audio content source, or any other suitable source). While in the first mode, the portable playback device can play back the audio content.

The method 1300 proceeds to block 1304, in which the media play back system can transition from the first mode to a second mode based on one or more of a proximity parameter, a power parameter, and/or a grouping parameter. At block 1306, the method 1300 involves, while in the second mode, playing back only a first portion of the audio content via the portable playback device and playing back a second portion of the audio content via a stationary plug-in playback device. In some examples, the second portion of the audio content can include more bass-heavy content (e.g., more audio content below a predetermined threshold frequency, such as about 80 Hz or other suitable threshold frequency). Because bass-heavy audio content can consume more power during playback than higher frequency audio content, offloading bass-heavy audio content to the stationary plug-in playback device can significantly decrease the power consumption of the portable playback device. In various examples, the threshold frequency can be about 40, 50, 60, 70, 80, 90, 100, 110, 120, 130, 140, 150, 160, 170, 180, 190, or 200 Hz. In some examples, the threshold frequency can vary based on the proximity parameter and/or the power parameter, and optionally may vary over time.

According to some examples, while in the second mode the stationary plug-in playback device may play back only audio content below the predetermined threshold frequency. This may be particularly useful in masking the fact that the stationary plug-in playback device is augmenting playback via the portable playback device. Additionally, because bass content is more omnidirectional than higher frequency audio content, bass content provided by a nearby but still separately located stationary plug-in playback device may not be noticeable to the user listening to audio via the portable playback device.

In some instances, the portable playback device can play back audio content according to different spectral calibration profiles in the first and second modes. The particular spectral calibration of the portable playback device while in the second mode may depend at least in part on the acoustic profile of the stationary plug-in playback device. For example, if the stationary plug-in playback device is highly equipped to output bass-heavy content (e.g., the stationary plug-in playback device is a dedicated subwoofer or device equipped with a woofer), then in the second mode the portable playback device may adopt a spectral calibration profile that outputs little or no low-frequency content. Conversely, if the stationary plug-in playback device is less well equipped to output bass-heavy content (e.g., the stationary plug-in playback device is a smaller device with less low-frequency output capability), then in the second mode the portable playback device may adopt a spectral calibration profile that still outputs some low-frequency content, although optionally still a lesser amount of low-frequency output than while in the first mode.

The proximity parameter can include or be based on a determined distance between the portable playback device and other playback device(s) within the environment, whether portable unplugged devices, portable plugged-in devices, stationary plug-in devices, or otherwise. For example, the proximity parameter can include an indication that another playback device is within a predetermined distance of the portable playback device. Additionally or alternatively, this proximity determination can indicate that the other playback device is within a predetermined distance of the portable playback device for at least a predetermined threshold amount of time. This approach can avoid undesirable transitions while the portable playback device is being moved and is only temporarily in close proximity to another playback device.

In some instances, a volume of playback of the second portion of the audio content via the stationary plug-in playback device can depend at least in part on the proximity parameter. For example, if the devices are very near to one another, the stationary plug-in playback device may play back the second portion of the audio content at a lower volume than if the devices are further apart. In some examples, an onboard microphone of one playback device can detect audio played back by another audio playback device, and vice versa. These detected audio can be used as feedback to adjust playback of one or both devices.

As noted above, in various examples, the indication that one or more other playback devices are in proximity to the portable playback device can be based on one or more localization signals exchanged between the portable playback device and the other playback device(s), and/or localization signals between these devices and other network devices within the environment (e.g., a controller device, other playback devices, etc.). Additional details and examples of determining relative positions of playback devices within an environment can be found in commonly owned U.S. Application No. 62/261,876, filed Sep. 30, 2021, titled “Spatial Mapping of Media Playback System Components,” which is hereby incorporated by reference in its entirety and included as an Appendix to this application.

In some instances, transitioning to the second mode can include automatically grouping the portable playback device with another playback device for synchronous play back based on the proximity parameter. Optionally, such grouping can be performed without visible presentation to the user (e.g., the group may not be presented to the user via an interface via controller device or otherwise). In this manner, the user may not be aware that the portable playback device has transitioned to the second mode. In other instances, such grouping may be visible to the user (e.g., presented to the user via an interface via controller device or otherwise).

The power parameter can include an energy storage level of the portable playback device energy storage, a power consumption rate of the portable playback device, an output volume level of the portable playback device and/or other playback devices, an acoustic efficiency profile of the portable playback device and/or the stationary playback device, or a temperature associated with the portable playback device storage. In some instances, the portable playback device can transition to the second mode when the power level drops below a predetermined threshold level, or a rate of power consumption rises above a predetermined threshold rate. Additionally, the acoustic efficiency profile of the portable play back device may determine, at least in part, whether to transition to the second mode. The acoustic efficiency profile may depend both on the particular features of a playback device (e.g., number and type of transducers), and the power consumption may be a function of the particular audio content being played back, the acoustic efficiency profile, and the playback volume. The temperature associated with the portable playback device storage can be obtained via an on-board temperature sensor or other suitable approach. In some instances, the temperature of the energy storage can affect the rate of power consumption. Moreover, excessively high temperatures may damage the energy storage or other components of the device, and as such temperatures above a predetermined threshold may trigger a transition to a second mode in order to reduce the temperature associated with the portable playback device storage. Among examples, the transition from the first mode to the second mode can be responsive to the temperature associated with the portable playback device energy storage rising above a predetermined first threshold, and the transition from the second mode back to the first mode can be responsive to the temperature associated with the portable device energy storage falling below a predetermined threshold. These thresholds can be the same (e.g., both transitions occur at 50 degrees Celsius), or may differ (e.g., transition to second mode when the temperature exceeds 50 degrees Celsius, but transition back to first mode only when the temperature falls below 40 degrees Celsius). Either or both threshold temperatures can be, for example, about 5, 10, 15, 20, 25, 30, 35, 40, 45, 50, 55, 60, 65, 70, 75, or 80 degrees Celsius.

In some examples, the transition from the first mode to the second mode can be in response to the power level of the portable playback device energy storage falling below a predetermined first threshold, and transitioning from the second mode back to the first mode can be in response to the power level of the portable playback device rising above a predetermined second threshold. These thresholds can be the same (e.g., both transitions occur at 20% charge), or may differ (e.g., transition to second mode when energy storage falls below 20%, but transition back to first mode only when energy storage rises above 60%). Either or both threshold energy storages can be, for example, about 5%, 10%, 15%, 20%, 25%, 30%, 35%, 40%, 45%, 50%, 55%, 60%, 65%, 70%, 75%, 80%, 85%, 90%, or 95% of the full charge capacity of the portable playback device energy storage.

In some examples, a playback device may inhibit or preclude battery charging if the battery is below a certain temperature threshold and self-heat the battery until it is at a suitable operating and/or charging temperature. For example, in some cases if the battery temperature is below a certain threshold (e.g., temp.≤0° C.), the battery may be configured to self-heat until its temp is above a threshold (e.g., temp.>0° C.), and the playback device may preclude charging only until the battery temperature is above the threshold. Such charging scheme can improve, among other things, battery efficiency. For example, the efficiency of lithium-ion batteries is substantially decreased at temperatures below ° C. In some embodiments, a battery may operate in a high-power mode for purposes of self-heating to heat the battery until it reaches a suitable temperature for charging and/or other operation. Such self-heating to a certain temperature threshold may extend the total play time compared to a playback device that is allowed to operate below the temperature threshold.

The grouping parameter can include, for example, an indication that the portable playback device is grouped with another playback device for synchronous playback (e.g., a stationary plug-in playback device, another portable playback device (whether plugged in or unplugged), etc.).

FIG. 14 illustrates another example method 1400 in accordance with examples of the present technology. As described below, the method 1400 involves playing back audio content via two portable playback devices in accordance with two different modes. In the first mode, the first and second portable playback devices can each play back audio content according to first and second spectral calibration profiles, respectively, which may be the same or may differ from one another. While in a second mode, the first and second portable playback devices can each play back audio content according to third and fourth spectral calibration profiles, respectively. The fourth calibration profile can cause the second portable playback device to output less low-frequency audio content than the second calibration profile. Optionally, the third calibration profile can cause the first portable playback device to output greater low-frequency audio content than the first calibration profile. As such, the second portable playback device may consume less power during playback in the second mode than while in the first mode. This can be useful to conserve power when one portable playback device, reaching a low-power state, can offload at least a portion of its playback responsibilities to another nearby portable playback device. The portable playback devices can transition between the first mode and the second mode based on a proximity parameter and/or a power parameter of the first portable playback device and/or the second portable playback device.

Referring to FIG. 14, the method 1400 begins at block 1402, which involves, while in a first mode, synchronously playing back audio content via a first portable playback device according to a first calibration profile and via a second portable playback device according to a second calibration profile. For example, the first and second portable playback devices can each receive audio content (e.g., from a group coordinator device within the media playback system, from an external source via a network interface, from another playback device of the same media playback system, a local audio content source, or any other suitable source). In various examples, the first and second calibration profiles can be substantially identical or may differ from one another. In at least some instances, the first and second calibration profiles can cause the first and second portable playback devices to play back substantially full-frequency audio content.

At block 1404, the method 1400 involves transitioning between the first mode and a second mode based on a proximity parameter and/or a power parameter. And in block 1406, the method 1400 involves, while in the second mode, synchronously playing back audio content via the first portable playback device according to a third calibration profile and via the second portable playback device according to a fourth calibration profile. In some examples, the fourth calibration profile differs from the second calibration profile and causes the second playback device to output less low-frequency content (e.g., content below a predetermined threshold frequency, such as about 80 Hz or other suitable threshold frequency) than according to the second calibration profile. In this manner, at least a portion of the low-frequency audio output playback responsibilities are offloaded from the portable playback device when the device transitions from the first mode to the second mode. Because bass-heavy audio content can consume more power during playback than higher frequency audio content, offloading bass-heavy audio content from the second portable playback device can significantly decrease its power consumption. In various examples, the threshold frequency can be about 40, 50, 60, 70, 80, 90, 100, 110, 120, 130, 140, 150, 160, 170, 180, 190, or 200 Hz. In some examples, the threshold frequency can vary based on the proximity parameter and/or the power parameter. Optionally, while in the second mode the first portable playback device can play back more audio content below the predetermined threshold than while in the first mode. For instance, some of the low-frequency audio content that would otherwise be played back by the second portable playback device can instead be played back via the first portable playback device. As such, the low-frequency playback responsibilities of the first portable playback device can increase from the first calibration profile to the second calibration profile.

In some examples, the system can dynamically modify a calibration profile of the first portable playback device and/or the second portable playback device based at least in part on a first energy storage level of the first portable playback device and/or a second energy storage level of the second portable playback device. This dynamic modification can include, for example, modifying one or both calibration profiles based at least in part on a projected energy storage depletion rate of the first energy storage and/or the second energy storage. For example, if the projected energy storage depletion rate indicates that the energy storage level will fall below a predetermined threshold within a short period of time (e.g., within 30 minutes), the dynamic modification can result in offloading a greater proportion of the audio content (e.g., a greater proportion of low-frequency audio content) for that playback device. Conversely, if the projected energy storage depletion rate indicates that the energy storage level will not fall below the predetermined threshold for an extended period of time (e.g., within 4 hours), the dynamic modification can result in offloading a lesser proportion of the audio content (e.g., a lesser proportion of the low-frequency audio content) for that playback device. In some implementations, this dynamic modification of the calibration profiles can be used to achieve a target power draw-down rate, for example to bring the two playback devices nearer to one another in projected power draw rates and/or projected time of energy storage depletion.

The power parameter can include or relate to a power level of the portable playback device(s) energy storage, a power consumption rate of the portable playback device(s), an output volume level of the portable playback device(s), and/or other playback devices, an acoustic efficiency profile of the portable playback device(s), and/or a temperature associated with the portable playback device(s) storage. In some examples, the transition between first mode and second mode can be based on energy storage levels of the two devices. For example, the system can transition from the first mode to second mode when the first energy storage level of the first portable playback device is higher than second energy storage level of second portable playback device. Further, the system can transition from the second mode back to the first mode when the first energy storage level of the first portable playback device is equal to or lower than the second energy storage level of the second portable playback device.

The proximity parameter can include or be based on a determined distance between the first portable playback device and the second portable playback device. For example, the proximity parameter can include an indication that the first portable playback device is within a predetermined distance (and optionally for a predetermined amount of time) of the second portable playback device, and/or a distance between one or more playback devices and a listener. Such distance determinations can be based at least in part on one or more localization signals exchanged between the first portable playback device and the second portable playback device, or between either or both of these devices and other network devices within the environment (e.g., a controller device, other playback devices, etc.). Distance determinations may also be based on a proximity of the player to a listener or the “sound stage.” Stationary devices located relatively further from the sound stage may also supplement sound low frequency energy to extend a portable player's battery efficiency. Additional details and examples of determining relative positions of playback devices within an environment can be found in commonly owned U.S. Pat. No. 9,729,115, filed Apr. 27, 2012, titled “Intelligently Increasing the Sound Level of Player” and U.S. Application No. 62/261,876, filed Sep. 30, 2021, titled “Spatial Mapping of Media Playback System Components,” which are hereby incorporated by reference in their entireties and included as an Appendix to this application.

### VI. Conclusion

The above discussions relating to playback devices, controller devices, wireless power transfer devices, playback zone configurations, and media/audio content sources provide only some examples of operating environments within which functions and methods described below may be implemented. Other operating environments and configurations of power transfer systems, media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

The present technology is illustrated, for example, according to various aspects described below. Various examples of aspects of the present technology are described as numbered examples for convenience. These are provided as examples and do not limit the present technology. It is noted that any of the dependent examples may be combined in any combination, and placed into a respective independent example. The other examples can be presented in a similar manner.

Example 1: A media playback system comprising: a portable playback device comprising an energy storage, one or more first audio transducers, and one or more first processors; a stationary plug-in playback device comprising one or more audio second transducers and one or more second processors; one or more computer-readable media storing instructions that, when executed by the one or more first processors and/or the one or more second processors of the media playback system, cause the media playback system to perform operations comprising: receiving audio content from an audio source; while in a first mode, playing back the audio content via at least the portable playback device; while in a second mode, playing back only a first portion of the audio content via the portable playback device and playing back a second portion of the audio content via the stationary plug-in playback device, wherein the second portion of the audio content includes more audio content below about a predetermined frequency threshold than the first portion of the audio content; and transitioning between the first mode and the second mode based on one or more of: a proximity parameter of the portable playback device and/or the stationary plug-in playback device, a power parameter of the portable playback device and/or the stationary plug-in playback device, or a grouping parameter of the portable playback device and/or the stationary plug-in playback device.

Example 2: The media playback system of any one of the Examples herein, wherein the grouping parameter comprises an indication that the portable playback device and the stationary plug-in playback device are grouped together for synchronous audio playback.

Example 3: The media playback system of any one of the Examples herein, wherein the operations further comprise: automatically grouping the portable playback device and the stationary plug-in playback device for synchronous playback based on the proximity parameter.

Example 4: The media playback system of any one of the Examples herein, wherein the proximity parameter comprises an indication that the stationary plug-in playback device is within a predetermined distance of the portable playback device.

Example 5: The media playback system of any one of the Examples herein, wherein the proximity parameter comprises an indication that the stationary plug-in playback device is within the predetermined distance of the portable playback device for at least a threshold amount of time.

Example 6: The media playback system of any one of the Examples herein, wherein the indication is based on one or one or more localization signals exchanged between the portable playback device and the stationary plug-in playback device.

Example 7: The media playback system of any one of the Examples herein, wherein a volume of playback of the second portion of the audio content via the stationary plug-in playback device depends at least in part on the proximity parameter.

Example 8: The media playback system of any one of the Examples herein, wherein the volume of playback of the second portion of the audio content is lower when the stationary plug-in playback device is further from the portable playback device than when the stationary plug-in playback device is closer to the portable playback device.

Example 9: The media playback system of any one of the Examples herein, wherein the power parameter comprises one or more of: a power level of the portable playback device energy storage; an output volume level of the portable playback device and/or the stationary plug-in playback device; an acoustic efficiency profile of the portable playback device and/or the stationary plug-in playback device; a battery parameter, or a temperature associated with the portable playback device energy storage.

Example 10: The media playback system of any one of the Examples herein, wherein the operations comprise transitioning from the first mode to the second mode in response to the power level of the portable playback device energy storage falling below a predetermined first threshold, and transitioning from the second mode to the first mode in response to the power level of the portable playback device rising above a predetermined second threshold.

Example 11: The media playback system of any one of the Examples herein, wherein the operations comprise transitioning from the first mode to the second mode in response to the temperature associated with the portable playback device energy storage rising above a predetermined first threshold, and transitioning from the second mode to the first mode in response to the temperature associated with the portable playback device falling below a predetermined second threshold.

Example 12: The media playback system of any one of the Examples herein, wherein, in the second mode, the stationary plug-in playback device plays back only the second portion of the audio content, and wherein the second portion of the audio content includes only audio content below a threshold frequency.

Example 13: The media playback system of any one of the Examples herein, wherein the threshold frequency can vary based on one or more of: the proximity parameter or the power parameter.

Example 14: The media playback system of any one of the Examples herein, wherein, in the first mode, the portable playback device plays back the audio content according to a first spectral calibration profile, and in the second mode, the portable playback device plays back the first portion of the audio content according to a second spectral calibration profile that is different from the first.

Example 15: The media playback system of any one of the Examples herein, wherein the second spectral calibration profile depends at least in part on an acoustic profile of the stationary plug-in playback device.

Example 16: The media playback system of any one of the Examples herein, wherein the predetermined frequency threshold is about 80 Hz.

Example 17: A method comprising: receiving audio content from an audio source; while in a first mode, playing back audio content via at least a portable playback device comprising an energy storage and one or more first audio transducers; while in a second mode, playing back only a first portion of the audio content via the portable playback device and playing back a second portion of the audio content via a stationary plug-in playback device comprising one or more second audio transducers, wherein the second portion of the audio content includes more audio content below about a predetermined frequency threshold than the first portion of the audio content; and transitioning between the first mode and the second mode based on one or more of: a proximity parameter of the portable playback device and/or the stationary plug-in playback device, a power parameter of the portable playback device and/or the stationary plug-in playback device, or a grouping parameter of the portable play back device and/or the stationary plug-in playback device.

Example 18: The method of any one of the Examples herein, wherein the grouping parameter comprises an indication that the portable playback device and the stationary plug-in playback device are grouped together for synchronous audio playback.

Example 19: The method of any one of the Examples herein, further comprising: automatically grouping the portable playback device and the stationary plug-in playback device for synchronous playback based on the proximity parameter.

Example 20: The method of any one of the Examples herein, wherein the proximity parameter comprises an indication that the stationary plug-in playback device is within a predetermined distance of the portable playback device.

Example 21: The method of any one of the Examples herein, wherein the proximity parameter comprises an indication that the plug-in playback device is within the predetermined distance of the portable playback device for at least a threshold amount of time.

Example 22: The method of any one of the Examples herein, wherein the indication is based on one or one or more localization signals exchanged between the portable playback device and the stationary plug-in playback device.

Example 23: The method of any one of the Examples herein, wherein a volume of playback of the second portion of the audio content via the stationary plug-in playback device depends at least in part on the proximity parameter.

Example 24: The method of any one of the Examples herein, wherein the volume of playback of the second portion of the audio content is lower when the stationary plug-in playback device is further from the portable playback device than when the stationary plug-in playback device is closer to the portable playback device.

Example 25: The method of any one of the Examples herein, wherein the power parameter comprises one or more of: a power level of the portable playback device energy storage; an output volume level of the portable playback device and/or the stationary plug-in playback device; an acoustic efficiency profile of the portable playback device and/or the stationary plug-in playback device; a battery parameter; or a temperature associated with the portable playback device energy storage.

Example 26: The method of any one of the Examples herein, further comprising transitioning from the first mode to the second mode in response to the power level of the portable playback device energy storage falling below a predetermined first threshold, and transitioning from the second mode to the first mode in response to the power level of the portable playback device rising above a predetermined second threshold.

Example 27: The method of any one of the Examples herein, further comprising transitioning from the first mode to the second mode in response to the temperature associated with the portable playback device energy storage rising above a predetermined first threshold, and transitioning from the second mode to the first mode in response to the temperature associated with the portable playback device falling below a predetermined second threshold.

Example 28: The method of any one of the Examples herein, wherein, in the second mode, the stationary plug-in playback device plays back only the second portion of the audio content, and wherein the second portion of the audio content includes only audio content below a threshold frequency.

Example 29: The method of any one of the Examples herein, wherein the threshold frequency can vary based on one or more of: the proximity parameter or the power parameter.

Example 30: The method of any one of the Examples herein, wherein, in the first mode, the portable playback device plays back the audio content according to a first spectral calibration profile, and in the second mode, the portable playback device plays back the first portion of the audio content according to a second spectral calibration profile that is different from the first.

Example 31: The method of any one of the Examples herein, wherein the second spectral calibration profile depends at least in part on an acoustic profile of the stationary plug-in playback device.

Example 32: The method of any one of the Examples herein, wherein the predetermined frequency threshold is about 80 Hz.

Example 33: One or more tangible, non-transitory computer-readable media storing instructions that, when executed by one or more processors of a media playback system, cause the media playback system to perform operations comprising: receiving audio content from an audio source; while in a first mode, playing back the audio content via at least a portable playback device comprising an energy storage and one or more first audio transducers; while in a second mode, playing back only a first portion of the audio content via the portable playback device and playing back a second portion of the audio content via a stationary plug-in playback device comprising one or more second audio transducers, wherein the second portion of the audio content includes more audio content below about a predetermined frequency threshold than the first portion of the audio content; and transitioning between the first mode and the second mode based on one or more of: a proximity parameter of the portable playback device and/or the stationary plug-in playback device, a power parameter of the portable playback device and/or the stationary plug-in playback device, or a grouping parameter of the portable playback device and/or the stationary plug-in playback device.

Example 34: The computer-readable media of any one of the Examples herein, wherein the grouping parameter comprises an indication that the portable playback device and the stationary plug-in playback device are grouped together for synchronous audio playback.

Example 35: The computer-readable media of any one of the Examples herein, wherein the operations further comprise: automatically grouping the portable playback device and the stationary plug-in playback device for synchronous playback based on the proximity parameter.

Example 36: The computer-readable media of any one of the Examples herein, wherein the proximity parameter comprises an indication that the stationary plug-in playback device is within a predetermined distance of the portable playback device.

Example 37: The computer-readable media of any one of the Examples herein, wherein the proximity parameter comprises an indication that the plug-in playback device is within the predetermined distance of the portable playback device for at least a threshold amount of time.

Example 38: The computer-readable media of any one of the Examples herein, wherein the indication is based on one or one or more localization signals exchanged between the portable playback device and the stationary plug-in playback device.

Example 39: The computer-readable media of any one of the Examples herein, wherein a volume of playback of the second portion of the audio content via the stationary plug-in playback device depends at least in part on the proximity parameter.

Example 40: The computer-readable media of any one of the Examples herein, wherein the volume of playback of the second portion of the audio content is lower when the stationary plug-in playback device is further from the portable playback device than when the stationary plug-in playback device is closer to the portable playback device.

Example 41: The computer-readable media of any one of the Examples herein, wherein the power parameter comprises one or more of: a power level of the portable playback device energy storage; an output volume level of the portable playback device and/or the stationary plug-in playback device; an acoustic efficiency profile of the portable playback device and/or the stationary plug-in playback device; a battery parameter, or a temperature associated with the portable playback device energy storage.

Example 42: The computer-readable media of any one of the Examples herein, wherein the operations comprise transitioning from the first mode to the second mode in response to the power level of the portable playback device energy storage falling below a predetermined first threshold, and transitioning from the second mode to the first mode in response to the power level of the portable playback device rising above a predetermined second threshold.

Example 43: The computer-readable media of any one of the Examples herein, wherein the operations comprise transitioning from the first mode to the second mode in response to the temperature associated with the portable playback device energy storage rising above a predetermined first threshold, and transitioning from the second mode to the first mode in response to the temperature associated with the portable playback device falling below a predetermined second threshold.

Example 44: The computer-readable media of any one of the Examples herein, wherein, in the second mode, the stationary plug-in playback device plays back only the second portion of the audio content, and wherein the second portion of the audio content includes only audio content below a threshold frequency.

Example 45: The computer-readable media of any one of the Examples herein, wherein the threshold frequency can vary based on one or more of: the proximity parameter or the power parameter.

Example 46: The computer-readable media of any one of the Examples herein, wherein, in the first mode, the portable playback device plays back the audio content according to a first spectral calibration profile, and in the second mode, the portable playback device plays back the first portion of the audio content according to a second spectral calibration profile that is different from the first.

Example 47: The computer-readable media of any one of the Examples herein, wherein the second spectral calibration profile depends at least in part on an acoustic profile of the stationary plug-in playback device.

Example 48: The computer-readable media of any one of the Examples herein, wherein the predetermined frequency threshold is about 80 Hz.

Example 49: A media playback system comprising: a first portable playback device comprising a first energy store, one or more first audio transducers, and one or more first processors; a second portable playback device comprising a second energy store, one or more second audio transducers, and one or more second processors; one or more computer-readable media storing instructions that, when executed by the one or more first processors and/or the one or more second processors of the media playback system, cause the media play back system to perform operations comprising: receiving audio content from an audio source; while in a first mode, synchronously playing back the audio content via the first portable playback device according to a first calibration profile and via the second portable playback device according to a second calibration profile; while in a second mode, synchronously playing back the audio content via the first portable playback device according to a third calibration profile and via the second portable playback device according to a fourth calibration profile, wherein according the fourth calibration profile the second portable playback device outputs less audio content below a predetermined frequency threshold than according to the second calibration profile; and transitioning between the first mode and the second mode based on one or more of a proximity parameter of the first portable playback device and/or the second portable play back device, or a power parameter of the first portable playback device and/or the second portable playback device.

Example 50: The media playback system of any one of the Examples herein, wherein the operations further comprise: dynamically modifying a calibration profile of the first portable playback device and/or the second portable playback device based at least in part on a first energy storage level of the first portable playback device and/or a second energy storage level of the second portable playback device.

Example 51: The media playback system of any one of the Examples herein, wherein the operations further comprise: dynamically modifying the calibration profiles of the first portable playback device and/or the second portable playback device based at least in part on a projected energy storage depletion rate of the first energy storage and/or the second energy storage.

Example 52: The media playback system of any one of the Examples herein, wherein the operations further comprise transitioning between the first mode and the second mode based on a first energy storage level of the first portable playback device and/or a second energy storage level of the second portable playback device.

Example 53: The media playback system of any one of the Examples herein, wherein the operations further comprise transitioning from the first mode to the second mode when the first energy storage level of the first portable playback device is higher than the second energy storage level of the second portable playback device.

Example 54: The media playback system of any one of the Examples herein, wherein the operations further comprise transitioning back from the second mode to the first mode when the first energy storage level of the first portable playback device is equal to or lower than the second energy storage level of the second portable playback device.

Example 55: The media playback system of any one of the Examples herein, wherein according the third calibration profile the first portable playback device outputs more audio content below 80 Hz than according to the first calibration profile.

Example 56: The media playback system of any one of the Examples herein, wherein the proximity parameter comprises an indication that the first portable playback device is within a predetermined distance of the second portable playback device.

Example 57: The media playback system of any one of the Examples herein, wherein the proximity parameter comprises an indication that the first portable playback device is within the predetermined distance of the second portable playback device for at least a threshold amount of time.

Example 58: The media playback system of any one of the Examples herein, wherein the indication is based on one or one or more localization signals exchanged between the first portable playback device and the second portable playback device.

Example 59: The media playback system of any one of the Examples herein, wherein the predetermined frequency threshold is about 80 Hz.

Example 60: A method comprising: receiving audio content from an audio source; while in a first mode, synchronously playing back the audio content via a first portable playback device according to a first calibration profile and via the second portable playback device according to a second calibration profile, wherein the first portable playback device comprises a first energy store and one or more first audio transducers, and the second portable playback device comprises a second energy store and one or more second audio transducers; while in a second mode, synchronously playing back the audio content via the first portable playback device according to a third calibration profile and via the second portable playback device according to a fourth calibration profile, wherein according the fourth calibration profile the second portable playback device outputs less audio content below a predetermined frequency threshold than according to the second calibration profile; and transitioning between the first mode and the second mode based on one or more of a proximity parameter of the first portable playback device and/or the second portable playback device, or a power parameter of the first portable playback device and/or the second portable playback device.

Example 61: The method of any one of the Examples herein, further comprising dynamically modifying a calibration profile of the first portable playback device and/or the second portable playback device based at least in part on a first energy storage level of the first portable playback device and/or a second energy storage level of the second portable playback device.

Example 62: The method of any one of the Examples herein, further comprising dynamically modifying the calibration profiles of the first portable playback device and/or the second portable playback device based at least in part on a projected energy storage depletion rate of the first energy storage and/or the second energy storage.

Example 63: The method of any one of the Examples herein, further comprising transitioning between the first mode and the second mode based on a first energy storage level of the first portable playback device and/or a second energy storage level of the second portable playback device.

Example 64: The method of any one of the Examples herein, further comprising transitioning from the first mode to the second mode when the first energy storage level of the first portable playback device is higher than the second energy storage level of the second portable playback device.

Example 65: The method of any one of the Examples herein, further comprising transitioning back from the second mode to the first mode when the first energy storage level of the first portable playback device is equal to or lower than the second energy storage level of the second portable playback device.

Example 66: The method of any one of the Examples herein, wherein according the third calibration profile the first portable playback device outputs more audio content below 80 Hz than according to the first calibration profile.

Example 67: The method of any one of the Examples herein, wherein the proximity parameter comprises an indication that the first portable playback device is within a predetermined distance of the second portable playback device.

Example 68: The method of any one of the Examples herein, wherein the proximity parameter comprises an indication that the first portable playback device is within the predetermined distance of the second portable playback device for at least a threshold amount of time.

Example 69: The method of any one of the Examples herein, wherein the indication is based on one or one or more localization signals exchanged between the first portable playback device and the second portable playback device.

Example 70: The method of any one of the Examples herein, wherein the predetermined frequency threshold is about 80 Hz.

Example 71: One or more tangible, non-transitory computer-readable media storing instructions that, when executed by one or more processors of a media playback system, cause the media playback system to perform operations comprising: receiving audio content from an audio source; while in a first mode, synchronously playing back the audio content via a first portable playback device according to a first calibration profile and via the second portable playback device according to a second calibration profile, wherein the first portable playback device comprises a first energy store and one or more first audio transducers, and the second portable playback device comprises a second energy store and one or more second audio transducers; while in a second mode, synchronously playing back the audio content via the first portable playback device according to a third calibration profile and via the second portable playback device according to a fourth calibration profile, wherein according the fourth calibration profile the second portable playback device outputs less audio content below a predetermined frequency threshold than according to the second calibration profile; and transitioning between the first mode and the second mode based on one or more of a proximity parameter of the first portable playback device and/or the second portable playback device, or a power parameter of the first portable playback device and/or the second portable playback device.

Example 72: The computer-readable media of any one of the Examples herein, wherein the operations further comprise: dynamically modifying a calibration profile of the first portable playback device and/or the second portable playback device based at least in part on a first energy storage level of the first portable playback device and/or a second energy storage level of the second portable playback device.

Example 73: The computer-readable media of any one of the Examples herein, wherein the operations further comprise: dynamically modifying the calibration profiles of the first portable playback device and/or the second portable playback device based at least in part on a projected energy storage depletion rate of the first energy storage and/or the second energy storage.

Example 74: The computer-readable media of any one of the Examples herein, wherein the operations further comprise transitioning between the first mode and the second mode based on a first energy storage level of the first portable playback device and/or a second energy storage level of the second portable playback device.

Example 75: The computer-readable media of any one of the Examples herein, wherein the operations further comprise transitioning from the first mode to the second mode when the first energy storage level of the first portable playback device is higher than the second energy storage level of the second portable playback device.

Example 76: The computer-readable media of any one of the Examples herein, wherein the operations further comprise transitioning back from the second mode to the first mode when the first energy storage level of the first portable playback device is equal to or lower than the second energy storage level of the second portable playback device.

Example 77: The computer-readable media of any one of the Examples herein, wherein according the third calibration profile the first portable playback device outputs more audio content below 80 Hz than according to the first calibration profile.

Example 78: The computer-readable media of any one of the Examples herein, wherein the proximity parameter comprises an indication that the first portable playback device is within a predetermined distance of the second portable playback device.

Example 79: The computer-readable media of any one of the Examples herein, wherein the proximity parameter comprises an indication that the first portable playback device is within the predetermined distance of the second portable playback device for at least a threshold amount of time.

Example 80: The computer-readable media of any one of the Examples herein, wherein the indication is based on one or one or more localization signals exchanged between the first portable playback device and the second portable playback device.

Example 81: The computer-readable media of any one of the Examples herein, wherein the predetermined frequency threshold is about 80 Hz.

1-27. (canceled)

28. A media playback system comprising:
a portable playback device comprising an energy storage, one or more first audio transducers, and one or more first processors;
a stationary plug-in playback device comprising one or more audio second transducers and one or more second processors;
one or more computer-readable media storing instructions that, when executed by the one or more first processors and/or the one or more second processors of the media playback system, cause the media playback system to perform operations comprising:
receiving audio content from an audio source;
while in a first mode, playing back the audio content via at least the portable playback device;
while in a second mode, playing back only a first portion of the audio content via the portable playback device and playing back a second portion of the audio content via the stationary plug-in playback device, wherein the second portion of the audio content includes more audio content below about a predetermined frequency threshold than the first portion of the audio content; and
transitioning between the first mode and the second mode based on one or more of: a proximity parameter of the portable playback device and/or the stationary plug-in playback device, a power parameter of the portable playback device and/or the stationary plug-in playback device, or a grouping parameter of the portable playback device and/or the stationary plug-in playback device.

29. The media playback system of claim 28, wherein the grouping parameter comprises an indication that the portable playback device and the stationary plug-in playback device are grouped together for synchronous audio playback.

30. The media playback system of claim 29, wherein the operations further comprise: automatically grouping the portable playback device and the stationary plug-in playback device for synchronous playback based on the proximity parameter.

31. The media playback system of claim 28, wherein the proximity parameter comprises an indication that the stationary plug-in playback device is within a predetermined distance of the portable playback device.

32. The media playback system of claim 28, wherein a volume of playback of the second portion of the audio content via the stationary plug-in playback device depends at least in part on the proximity parameter.

33. The media playback system of claim 28, wherein the power parameter comprises one or more of:
a power level of the portable playback device energy storage;
an output volume level of the portable playback device and/or the stationary plug-in playback device;
an acoustic efficiency profile of the portable playback device and/or the stationary plug-in playback device;
a battery health parameter; or
a temperature associated with the portable playback device energy storage.

34. The media playback system of claim 28, wherein, in the second mode, the stationary plug-in playback device plays back only the second portion of the audio content, and wherein the second portion of the audio content includes only audio content below a threshold frequency.

35. A method comprising:
receiving audio content from an audio source;
while in a first mode, playing back audio content via at least a portable playback device comprising an energy storage and one or more first audio transducers;
while in a second mode, playing back only a first portion of the audio content via the portable playback device and playing back a second portion of the audio content via a stationary plug-in playback device comprising one or more second audio transducers, wherein the second portion of the audio content includes more audio content below about a predetermined frequency threshold than the first portion of the audio content; and
transitioning between the first mode and the second mode based on one or more of: a proximity parameter of the portable playback device and/or the stationary plug-in playback device, a power parameter of the portable playback device and/or the stationary plug-in playback device, or a grouping parameter of the portable playback device and/or the stationary plug-in playback device.

36. The method of claim 35, wherein the grouping parameter comprises an indication that the portable playback device and the stationary plug-in playback device are grouped together for synchronous audio playback.

37. The method of claim 36, further comprising: automatically grouping the portable playback device and the stationary plug-in playback device for synchronous playback based on the proximity parameter.

38. The method of claim 35, wherein the proximity parameter comprises an indication that the stationary plug-in playback device is within a predetermined distance of the portable playback device.

39. The method of claim 35, wherein a volume of playback of the second portion of the audio content via the stationary plug-in playback device depends at least in part on the proximity parameter.

40. The method of claim 35, wherein the power parameter comprises one or more of:
a power level of the portable playback device energy storage;
an output volume level of the portable playback device and/or the stationary plug-in playback device;
an acoustic efficiency profile of the portable playback device and/or the stationary plug-in playback device;
a battery health parameter; or
a temperature associated with the portable playback device energy storage.

41. The method of claim 35, wherein, in the second mode, the stationary plug-in playback device plays back only the second portion of the audio content, and wherein the second portion of the audio content includes only audio content below a threshold frequency.

42. One or more tangible, non-transitory computer-readable media storing instructions that, when executed by one or more processors of a media playback system, cause the media playback system to perform operations comprising:
receiving audio content from an audio source;
while in a first mode, playing back the audio content via at least a portable playback device comprising an energy storage and one or more first audio transducers;
while in a second mode, playing back only a first portion of the audio content via the portable playback device and playing back a second portion of the audio content via a stationary plug-in playback device comprising one or more second audio transducers, wherein the second portion of the audio content includes more audio content below about a predetermined frequency threshold than the first portion of the audio content; and
transitioning between the first mode and the second mode based on one or more of: a proximity parameter of the portable playback device and/or the stationary plug-in playback device, a power parameter of the portable playback device and/or the stationary plug-in playback device, or a grouping parameter of the portable playback device and/or the stationary plug-in playback device.

43. The computer-readable media of claim 42, wherein the grouping parameter comprises an indication that the portable playback device and the stationary plug-in playback device are grouped together for synchronous audio playback.

44. The computer-readable media of claim 43, wherein the operations further comprise: automatically grouping the portable playback device and the stationary plug-in playback device for synchronous playback based on the proximity parameter.

45. The computer-readable media of claim 42, wherein the proximity parameter comprises an indication that the stationary plug-in playback device is within a predetermined distance of the portable playback device.

46. The computer-readable media of claim 42, wherein a volume of playback of the second portion of the audio content via the stationary plug-in playback device depends at least in part on the proximity parameter.

47. The computer-readable media of claim 42, wherein the power parameter comprises one or more of:
a power level of the portable playback device energy storage;
an output volume level of the portable playback device and/or the stationary plug-in playback device;
an acoustic efficiency profile of the portable playback device and/or the stationary plug-in playback device;
a battery health parameter; or
a temperature associated with the portable playback device energy storage.
